(19) United States
(12) Patent Application Publication
(10) Pub. No.: US 2026/0278412 A1
(43) Pub. Date: Sep. 17, 2026

(54) OFFLINE INFERENCE PERFORMANCE ANALYSIS OF AGENT WORKFLOWS

(71) Applicant: NVIDIA Corporation, Santa Clara, CA (US)

(72) Inventors: Michael David Demoret, Brooklyn, NY (US); Dhruv Nandakumar, Boston, MA (US)

(21) Appl. No.: 19/359,268

(22) Filed: Oct. 15, 2025

Related U.S. Application Data
(60) Provisional application No. 63/772,593, filed on Mar. 16, 2025.
(60) Provisional application No. 63/772,598, filed on Mar. 16, 2025.

(51) Int. Cl. G06N 5/02; G06N 5/043

(52) U.S. Cl. CPC G06N 5/027; G06N 5/043

(57) ABSTRACT

An AI agent system processes multiple AI agent workflows created with different frameworks, providing standardized abstractions and formatting functions. The toolkit generates instrumentation data and performance efficiency metrics for the workflows based on execution events, and outputs these metrics in a standardized format, allowing for efficient comparison and analysis of the workflows' performance.

### CROSS-REFERENCE TO RELATED APPLICATION

This application is a non-provisional of and claims priority to U.S. Provisional Application No. 63/772,598, filed March 16, 2025, and claims priority to U.S. Provisional Application No. 63/772,593, filed March 16, 2025, each of which is incorporated by reference herein in its entirety.

### TECHNICAL FIELD

This disclosure generally relates to AI agent workflow (e.g., artificial intelligence (AI) and/or language model (LM)) evaluation systems, and more particularly to computer-implemented architectures that facilitate intelligent assessment of AI/LM agent and/or AI agent workflow performance across multiple frameworks.

### BACKGROUND

Performance analysis mechanisms for AI agent workflows suffer from fundamental technical constraints that impede the advancement of enterprise-grade AI agentic systems. Current frameworks for building and deploying AI agents support observability and evaluation during runtime, but they are bottlenecked by limitations that prevent comprehensive performance optimization. These frameworks only work for agents implemented fully within their specific environment, making it challenging for developers to collect end-to-end metrics on agents implemented partially across multiple frameworks such as LangChain, LlamaIndex, CrewAI, and Semantic Kernel. This creates fragmented visibility where developers cannot obtain unified performance insights across heterogeneous AI agent architectures, resulting in optimization blind spots and suboptimal resource allocation decisions.

The technical problem extends beyond framework isolation into the realm of performance characterization, where current evaluation approaches focus primarily on agent accuracy and usability metrics without addressing inference performance characteristics, such as latency analysis, bottleneck identification, and token efficiency optimization. Traditional frameworks only consider the lifetime of a single request, failing to account for the complex performance dynamics that emerge during concurrent request processing. With large AI agentic workflows where different requests may traverse different execution paths, it becomes difficult to profile all components of a workflow when only specific branches are exercised during individual request cycles. Furthermore, existing solutions do not provide the capability to simulate multiple concurrency levels or identify performance bottlenecks that manifest only under concurrent load conditions, leaving developers without important insights needed for production deployment optimization.

The technical constraints further manifest in the inability to perform cross-framework behavioral analysis, where developers may need to manually iterate through time-consuming cycles of performance testing, configuration adjustment, and re-evaluation across disparate agent implementations. This manual intervention creates a development bottleneck as performance optimization parameters such as LLM selection, tool calling strategies, and workflow orchestration patterns need to be individually assessed without standardized metrics or unified instrumentation capabilities. The lack of automated, framework-agnostic performance analysis mechanisms forces developers to make optimization decisions based on incomplete visibility into their agent workflows, resulting in suboptimal inference performance, unnecessary computational resource expenditure, and unpredictable scaling behavior in production environments.

### BRIEF DESCRIPTION OF THE DRAWINGS

The present systems and methods are described in detail below with reference to the attached drawing figures. To easily identify the discussion of any particular element or act, the most significant digit or digits in a reference number refer to the figure number in which that element is first introduced. In the drawing figures:

FIG. 1 illustrates an AI agent system, according to at least some embodiments of the present disclosure.

FIG. 2 is an AI agent workflow diagram, according to at least some embodiments of the present disclosure.

FIG. 3 illustrates an instrumentation data generation system, according to at least some embodiments of the present disclosure.

FIG. 4 illustrates an evaluation system, according to at least some embodiments of the present disclosure.

FIG. 5 illustrates an evaluation system, according to at least some embodiments of the present disclosure.

FIG. 6 is a flowchart illustrating an example method performed by the AI agent system, according to at least some embodiments of the present disclosure.

FIG. 7A is a block diagram of an example generative language model system suitable for use in implementing at least some embodiments of the present disclosure.

FIG. 7B is a block diagram of an example generative language model that includes a transformer encoder-decoder suitable for use in implementing at least some embodiments of the present disclosure.

FIG. 7C is a block diagram of an example generative language model that includes a decoder-only transformer architecture suitable for use in implementing at least some embodiments of the present disclosure.

FIG. 8 is a block diagram of an example computing device suitable for use in implementing at least some embodiments of the present disclosure.

FIG. 9 is a block diagram of an example data center suitable for use in implementing at least some embodiments of the present disclosure.

### DETAILED DESCRIPTION

Systems and methods are disclosed related to offline inference performance analysis and optimization of AI agent workflows. Specifically, this disclosure generally relates to AI agent and/or AI agent workflow performance evaluation systems, and more particularly to computer-implemented architectures that facilitate comprehensive behavioral analysis and automated performance profiling of multi-framework agent workflows across distributed computing environments.

The disclosed system provides systems and methods for implementing intelligent offline performance analysis through an architecture that enables framework-agnostic instrumentation and standardized profiling of AI agent workflows regardless of their underlying implementation frameworks. The technology represents a significant advancement over conventional agent evaluation systems by creating a unified framework (e.g., an AI agent system or sometimes referred to as an AI agent toolkit) where custom callback handlers can automatically discover and instrument agent workflows built across heterogeneous frameworks including LangChain, LlamaIndex, CrewAI, and/or Semantic Kernel while maintaining complete end-to-end observability through standardized intermediate step streams. The disclosed system supports comprehensive multi-concurrency simulation that enables developers to identify performance bottlenecks, latency characteristics, and/or token efficiency patterns that emerge under concurrent request processing scenarios. The architecture extends beyond simple runtime monitoring to provide granular nested bottleneck analysis, workflow ancestry tracking, and/or behavioral characteristic identification at a level of detail previously impossible across multiple agent frameworks. This holistic approach enables optimization insights ranging from LLM inference latency and tool call efficiency to prompt token utilization and concurrency scaling behavior while maintaining developer workflow independence and supporting seamless integration with existing observability platforms through standardized data export mechanisms.

In some examples, the disclosed techniques involve processors with processing circuitry that operate an AI agent system designed to work with AI agent workflows created using different AI agent workflow frameworks. The AI agent system provides AI framework-agnostic abstractions of these AI agent workflows and processes their functions into a standardized format by wrapping individual functions with standardized input schemas, output schemas, and descriptions. The disclosed system generates instrumentation data for the AI agent workflows based on execution events, creates performance efficiency metrics from this instrumentation data, and outputs these metrics in a standardized format.

The disclosed system wraps agent functions with standardized interfaces that define the input schemas, output schemas, and descriptions, then registers these wrapped functions with the AI agent system that maintains information about tools, agents, and functions across the different AI agent frameworks used to create the workflows. To accomplish this standardization, the disclosed system inspects source code of the AI agent workflows to identify undeclared agent frameworks and automatically discovers language model (LM) frameworks used in function definitions by analyzing code structure or library imports. The AI agent system registers custom callback handlers for each identified undeclared agent framework to intercept framework invocations and generates standardized data for the AI agent workflows by extracting metadata such as input data, output data, or token usage from the intercepted framework invocations through the custom callback handlers.

The AI agent system normalizes the extracted metadata across different frameworks into a unified data model and publishes the normalized data to an intermediate step stream. The AI agent system receives events from functions publishing the normalized metadata to this intermediate step stream, appends hierarchy metadata including parent function calls and ancestry information to each event, forwards the events to registered subscribers through asynchronous callback handlers, and maintains a ledger of actions taken by the AI agent workflows during processing of each event. Multiple subscriber types including evaluation subscribers and profiler subscribers can subscribe to the intermediate step stream, allowing the AI agent system to export trace data to observability platforms using, for example, OpenTelemetry-compatible formats, convert intermediate steps into framework-specific visualization formats for different observability tools, and enable cross-framework observability where AI agent workflows built in one framework can be visualized using tools associated with a different framework.

The disclosed system executes AI agent workflows across multiple concurrency levels, simulating user load patterns by varying the number of simultaneous requests processed by the workflows. During this simulation, the AI agent system collects execution traces, generates standardized invocation traces that capture end-to-end workflow execution data, and generates performance efficiency metrics based on these standardized invocation traces. The analysis includes examining LM latency measurements across different parts of the AI agent workflows, calculating end-to-end workflow runtime statistics for each concurrency level, identifying performance bottlenecks by examining execution timestamps and function call durations for each workflow, and/or generating latency analysis reports representing the performance bottlenecks.

The AI agent system tracks function ancestry relationships to identify nested function call hierarchies, analyzes timestamps and event types to identify bottleneck locations within nested functions, and/or determines which LM calls or tool invocations are causing latencies that fail to meet latency criteria. For token efficiency analysis, the AI agent system captures input token counts and output token counts for each LM invocation within the AI agent workflows, records timestamps and metadata for tool calls and LM calls during execution, generates standardized data frames containing token usage patterns across different workflow stages, and computes token efficiency metrics as a function of prompt token versus completion token ratios based on the standardized data frames. Any operation discussed with respect to a LM can similarly be applied to any machine learning (ML) model and/or generative model.

An AI agent workflow in this context represents a sequence of processes that use a LM (or any other ML model) to reason through a problem and create a plan to solve the problem, involving iterative execution of the plan using a set of tools, and one or more AI agents that can call one or more tools of the set in a sequence or in parallel to accomplish specific tasks of the plan. The performance efficiency metrics encompass latency analysis metrics that measure LM latency and end-to-end workflow runtimes across different parts of an AI agent workflow, bottleneck analysis metrics that identify certain functions and specific language models or tool components causing latency using function ancestry or timestamps, concurrency analysis metrics that represent regions of high concurrency in AI agent workflow executions and estimate language model inference latency during peak usage periods, and token efficiency metrics that analyze input token versus completion token ratios and identify token usage patterns at various stages of the AI agent workflow.

The instrumentation data includes execution event data captured through custom callback handlers containing timestamps, input data, output data, or token usage for each language model call, tool call, or function call, function ancestry information that tracks which functions called other functions and maintains hierarchical relationships between AI agent workflow components, metadata extracted from framework invocations, and intermediate step stream data that provides a standardized ledger of actions taken by the AI agent workflow during execution of each AI agent workflow.

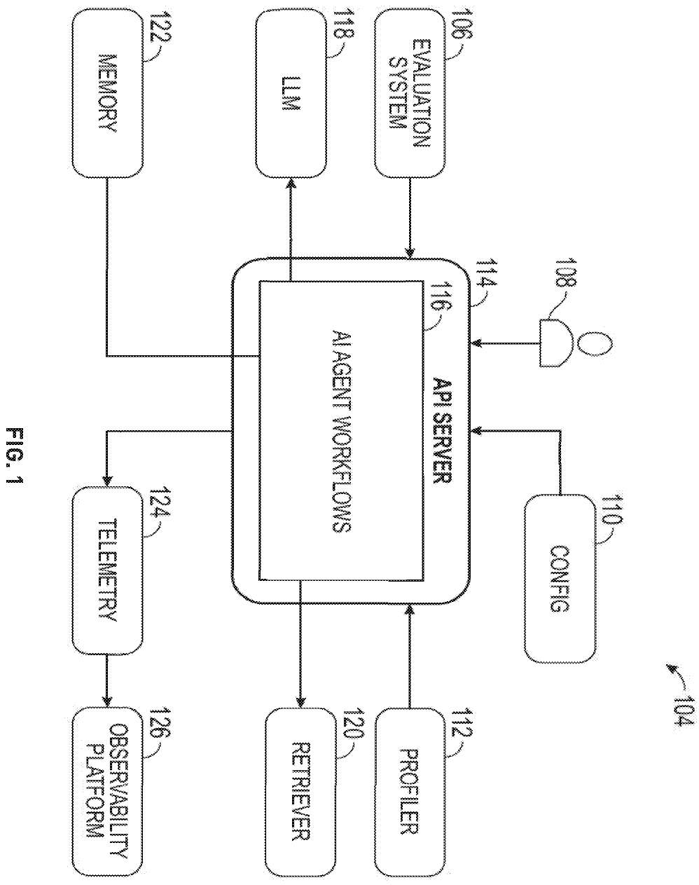

FIG. 1 illustrates an AI agent system 104, according to at least some embodiments of the present disclosure. Specifically, FIG. 1 illustrates a comprehensive AI agent system that may enable framework-agnostic performance analysis and evaluation of AI agent workflows 116 across multiple implementation frameworks. The AI agent system 104 may provide a unified platform for analyzing AI agent workflow (also referred to as agents or AI agents) performance regardless of whether the agents are implemented in LangChain, LlamaIndex, CrewAI, Semantic Kernel, or other agent frameworks. The architecture may support both offline profiling and real-time observability of agent workflows while maintaining compatibility with existing agent development frameworks.

The central component API server 114 may serve as the primary interface through which users, such as user 108, interact with the AI agent system 104 system. This API server 114 component may receive requests from developers seeking to analyze their agent workflows and may coordinate the various analysis and profiling operations across the system. The API server 114 may provide standardized endpoints that allow developers to submit their agent workflows for analysis without requiring modifications to their existing agent implementations.

In some examples, developers (user 108) may upload their workflows through multiple mechanisms, including direct code submission via REST API endpoints, configuration file uploads using YAML-based workflow definitions, and/or through integration with existing development environments where the API server 114 can access workflow repositories or containerized agent implementations. The API server 114 may implement both manual and/or automated framework detection capabilities to identify which agent frameworks are being used in submitted workflows. For manual detection, developers may explicitly declare the frameworks they are using through configuration parameters or metadata tags when submitting their workflows, such as specifying LangChain, LlamaIndex, CrewAI, Semantic Kernel, or other supported frameworks. The AI agent system 104 may provide standardized configuration templates that allow developers to indicate which frameworks power different components of their multi-framework agent implementations.

For automated framework detection, the API server 114 may coordinate with framework discovery components that inspect source code at build time to identify undeclared agent frameworks. This automated detection process may analyze code structure, library imports, function signatures, and dependency declarations to infer which agent frameworks are being used even when not explicitly declared by developers. The AI agent system 104 may employ pattern matching algorithms that recognize framework-specific coding patterns, API calls, and data structures characteristic of different agent frameworks. Once frameworks are identified through either manual declaration or automated discovery, the API server 114 may coordinate the registration of appropriate custom callback handlers for each detected framework, enabling comprehensive instrumentation and analysis capabilities across heterogeneous agent implementations.

The configuration 110 component may store and manage configuration parameters for the various analysis operations performed by the system. This configuration 110 component may contain settings that define how different agent frameworks should be instrumented, what metrics should be collected during analysis, and how concurrent request simulations should be conducted. The configuration 110 may also specify which observability platforms should receive exported trace data and may define evaluation criteria for different types of agent workflows.

The AI agent workflows 116 may represent the target agent implementations that are being analyzed by the system. These AI agent workflows 116 may be implemented using any combination of supported agent frameworks and may contain complex hierarchies of agents, tools, and other components. The AI agent workflows 116 may include agents built in LangChain that interact with tools developed in LlamaIndex, and/or may consist of single-framework implementations that still benefit from the cross-framework analysis capabilities provided by the system.

The profiler component 112 may perform offline inference performance analysis of the agent workflows by collecting and analyzing execution traces from workflow runs. This profiler may simulate multiple concurrent users interacting with agent workflows to identify performance bottlenecks that only manifest under concurrent load conditions. The profiler component 112 may generate latency analysis reports, conduct bottleneck analysis at the function level, and may identify token efficiency patterns across different stages of agent workflow execution.

The evaluation system 106 may assess agent workflows from multiple perspectives including accuracy, relevance, and/or behavioral performance characteristics. This evaluation system 106 may work with standardized evaluation datasets to provide consistent assessment criteria across different agent implementations. The evaluation system 106 may generate performance efficiency metrics that help developers understand how their agents behave under various operational conditions and may identify areas where workflow performance could be improved.

During operation, callback handlers of the AI agent system 104 may intercept framework invocations including LM calls, tool calls, and retriever calls across all supported frameworks. When an agent workflow executes, these handlers may extract metadata including input data, output data, token usage statistics, and execution timestamps from each intercepted invocation. This metadata extraction may occur transparently without requiring modifications to the underlying agent implementations.

The language model 118 component may represent language model integrations that are monitored and analyzed by the AI agent system 104. The system may track LM inference requests, measure response times, and may analyze token utilization patterns for prompt tokens versus completion tokens. The language model 118 analysis may help developers understand the efficiency of their language model usage and may identify opportunities for prompt reduction or caching.

The retriever component 120 may handle retrieval operations that are instrumented by the system for performance analysis. The AI agent system 104 may monitor retriever latency, analyze query patterns, and may identify retrieval bottlenecks that impact overall agent workflow performance. The retriever component 120 analysis may provide insights into how retrieval operations contribute to end-to-end workflow latency.

The memory 122 component may represent memory management operations that are tracked by the performance analysis system. The AI agent system 104 may monitor memory usage patterns, analyze conversation history management efficiency, and may identify memory-related bottlenecks in agent workflows. The memory 122 analysis may help developers understand how memory operations impact workflow performance across different concurrency levels.

The extracted metadata from all components may be normalized across different frameworks into a unified data model that gets published to an intermediate step stream. This normalization process may be enabled by the AI agent system's approach of wrapping individual functions with standardized input schemas, output schemas, and descriptions, regardless of whether those functions represent agents, tools, LLMs, or other workflow components. By wrapping each function in this standardized interface, the toolkit may create a common abstraction layer that allows framework-specific data structures to be converted into the unified data model. This function wrapping mechanism may ensure that LLM events, tool events, and other workflow events appear identical regardless of their originating framework, since all wrapped functions conform to the same standardized format with defined inputs, outputs, and descriptions. The standardized intermediate step stream may enable consistent analysis capabilities across heterogeneous agent implementations because the wrapped functions provide a framework-agnostic foundation for data collection and normalization.

For example, the extracted metadata normalization process operates by taking framework-specific data structures and converting them into a standardized intermediate representation that maintains semantic consistency across all supported agent frameworks. Namely, when a LangChain agent makes an LLM call, the callback handler extracts metadata that might include LangChain-specific fields such as: langchain.schema.messages.AIMessage; objects with nested content; and additional_kwargs fields, alongside timing data in LangChain's proprietary format. Simultaneously, when a LlamaIndex agent performs a similar LLM operation, its callback handler captures metadata in LlamaIndex's native format, which could include: llama_index.core.base.llms.types.ChatMessage objects with different field structures and timestamp representations. The normalization engine then transforms both of these disparate data structures into a unified format that includes standardized fields such as: input_text, output_text, prompt_tokens, completion_tokens, latency_ms, timestamp_iso, and function_ancestry, ensuring that an LLM call appears identical regardless of whether it originated from LangChain, LlamaIndex, CrewAI, or any other supported framework.

The intermediate step stream serves as the central nervous system for this standardized data flow, implementing a reactive publisher-subscriber architecture that maintains event ordering and hierarchy relationships across framework boundaries. When normalized metadata events are published to the stream, they can include enriched contextual information such as parent-child function relationships, execution depth levels, and cross-framework correlation identifiers that enable comprehensive workflow analysis. For instance, if an agent workflow begins with a LangChain ReAct agent that calls a LlamaIndex retriever tool, which subsequently invokes a CrewAI sub-agent, the intermediate step stream maintains a complete ancestry chain showing how langchain_react_agent.execute() called llamaindex_retriever.search() which then called crewai_specialist.analyze(). Each event in the stream contains standardized metadata fields including execution timestamps (e.g., start_time: 2025-01-15T14:30:25.123Z), token utilization metrics (e.g., prompt_tokens: 1247, completion_tokens: 389), and performance indicators (e.g., execution_duration_ms: 2340), enabling downstream subscribers to perform consistent analysis regardless of the underlying framework complexity.

This standardization process enables powerful cross-framework observability capabilities where evaluation subscribers, profiler subscribers, and observability platform exporters can all consume the same unified data stream without requiring framework-specific parsing logic. The stream supports multiple concurrent subscribers that can filter and process events based on standardized criteria, such as identifying all LLM calls with completion token counts exceeding, for example, 500 tokens or tracking function execution paths that span more than three different frameworks. Additionally, the intermediate step stream maintains ordering guarantees and supports replay capabilities, allowing profiler algorithms to reconstruct complete workflow execution timelines and identify performance bottlenecks at any level of the execution hierarchy, whether they occur within individual framework boundaries or at framework transition points where data must be marshaled between different agent implementations.

The telemetry component 124 may collect and manage performance metrics generated during workflow analysis. This telemetry system may gather timing data, resource utilization statistics, and workflow execution traces that enable comprehensive performance characterization. The telemetry component 124 may support multiple subscriber types that can access the telemetry data for different purposes including profiling, evaluation, and observability.

The AI agent system 104 may simulate user load patterns by varying the number of simultaneous requests processed by agent workflows. During these simulations, the AI agent system 104 may collect execution traces that capture end-to-end workflow execution data including function ancestry information and hierarchical relationships between workflow components. These traces may enable the identification of performance bottlenecks that only become apparent under concurrent load conditions.

The observability platform 126 component may receive exported trace data in OpenTelemetry-compatible formats for visualization and monitoring purposes. The AI agent system 104 may convert intermediate steps into framework-specific visualization formats that work with different observability tools. This capability may enable cross-framework observability where agents built in one framework can be visualized using tools associated with different frameworks.

The profiling algorithms implemented by the system may analyze collected trace data to generate various performance efficiency metrics. These algorithms may perform latency analysis across different parts of agent workflows, conduct nested bottleneck analysis using function ancestry tracking, and may identify regions of high concurrency in workflow executions. The analysis may also include token efficiency measurements that examine input token versus completion token ratios across different workflow stages.

The system may maintain a ledger of all actions taken by agent workflows during processing, enabling comprehensive behavioral analysis. This ledger may track which functions called other functions, maintain hierarchical relationships between workflow components, and may provide the foundation for identifying performance patterns that span multiple framework boundaries. The comprehensive tracking capability may enable performance insights that were previously impossible to obtain across multi-framework agent architectures.

The results generated by the AI agent system 104 may be output in standardized formats that enable developers to identify workflow performance characteristics and behavioral insights. These outputs may include performance efficiency metrics, bottleneck analysis reports, and token utilization patterns that help developers make informed decisions about agent workflow deployment and resource allocation. The standardized output format may ensure compatibility with various development tools and may facilitate integration with existing development workflows.

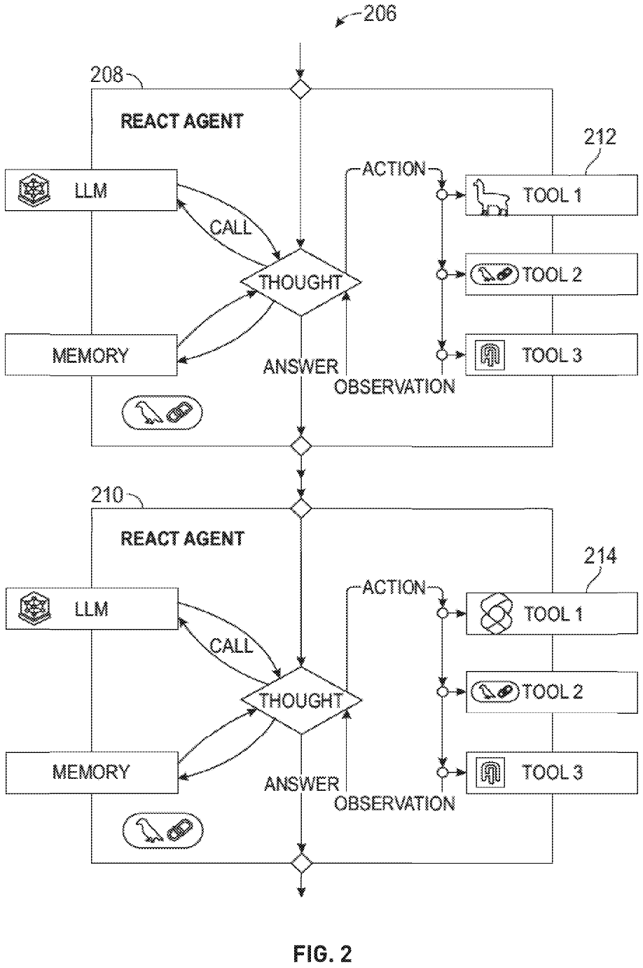

FIG. 2 is an AI agent workflow diagram 206, according to at least some embodiments of the present disclosure. Specifically, FIG. 2 illustrates the framework-agnostic capabilities of the AI agent system 104 system, demonstrating how multiple AI agent workflows created using different frameworks can be seamlessly integrated and analyzed through the unified instrumentation approach. The AI agent workflow diagram 206 shows two distinct ReAct agent implementations that may operate using different underlying frameworks while being monitored and analyzed through the same standardized data collection mechanisms.

The first AI agent workflow 208 represents a ReAct agent implementation that follows the standard reasoning and action cycle common to tool-calling agent systems. This first AI agent workflow 208 may operate by receiving input from users and processing it through a sequence involving an LLM component that reasons about the problem, determines which tools are needed, and coordinates the execution of those tools. The ReAct pattern shown enables the first AI agent workflow 208 to think through problems systematically, take actions using available tools, observe the results, and continue this cycle until reaching a satisfactory conclusion.

The first set of tools 212 associated with the first AI agent workflow 208 includes Tool 1, Tool 2, and Tool 3, each of which may be implemented using different frameworks or methodologies. These tools represent various capabilities that the agent can leverage to accomplish its objectives, such as information retrieval, data processing, mathematical calculations, or external API interactions. The AI agent system 104 system can instrument and monitor each of these tools regardless of their underlying implementation framework through the standardized callback handler system.

The second AI agent workflow 210 demonstrates the system's ability to handle multiple concurrent or related agent implementations that may utilize entirely different frameworks from the first workflow. This second ReAct agent follows the same general pattern of reasoning and action but may be optimized for different types of tasks or may represent an alternative implementation approach. The ability to simultaneously monitor and analyze multiple agent workflows enables developers to compare performance characteristics and behavioral patterns across different implementations. The second set of tools 214 provides additional capabilities that may complement or overlap with the tools in the first set, illustrating how the AI agent system 104 can manage complex multi-agent environments where different agents may share resources or operate on related tasks. The standardized instrumentation approach ensures that tool interactions and performance metrics can be collected consistently across both agent workflows, enabling comprehensive analysis of the entire multi-agent system.

The memory component shown in both workflows represents the conversation history and context management capabilities that enable agents to maintain state across multiple interactions. The AI agent system 104 can monitor memory operations to understand how conversation context affects agent performance and identify potential bottlenecks related to memory retrieval or storage operations. This monitoring capability extends across different memory implementations regardless of the underlying framework used.

The LLM components in both workflows represent the LM integration points that are important to agent operation. The system's callback handlers can intercept and monitor LLM calls from both agents, collecting standardized metrics including input token counts, output token counts, response latencies, and usage patterns. This unified monitoring approach enables cross-agent comparison of language model efficiency and identification of optimization opportunities.

The standardized intermediate step stream functionality enables both agent workflows to publish their execution events to the same unified data model, regardless of their underlying framework implementation. When either agent workflow executes, the custom callback handlers extract metadata from framework invocations and normalize this data across the different frameworks into the common format. This normalization process ensures that evaluation subscribers, profiler subscribers, and observability platform exporters can process events from both agents using the same analysis algorithms.

The AI agent workflow diagram 206 illustrates how the AI agent system's framework-agnostic abstractions enable complex multi-agent scenarios where different agents built using different frameworks can be deployed, monitored, and analyzed as part of a unified system. This capability allows developers to leverage the strengths of different frameworks while maintaining comprehensive observability and analysis capabilities across their entire agent ecosystem, supporting more sophisticated deployment scenarios and enabling detailed performance comparisons between different implementation approaches.

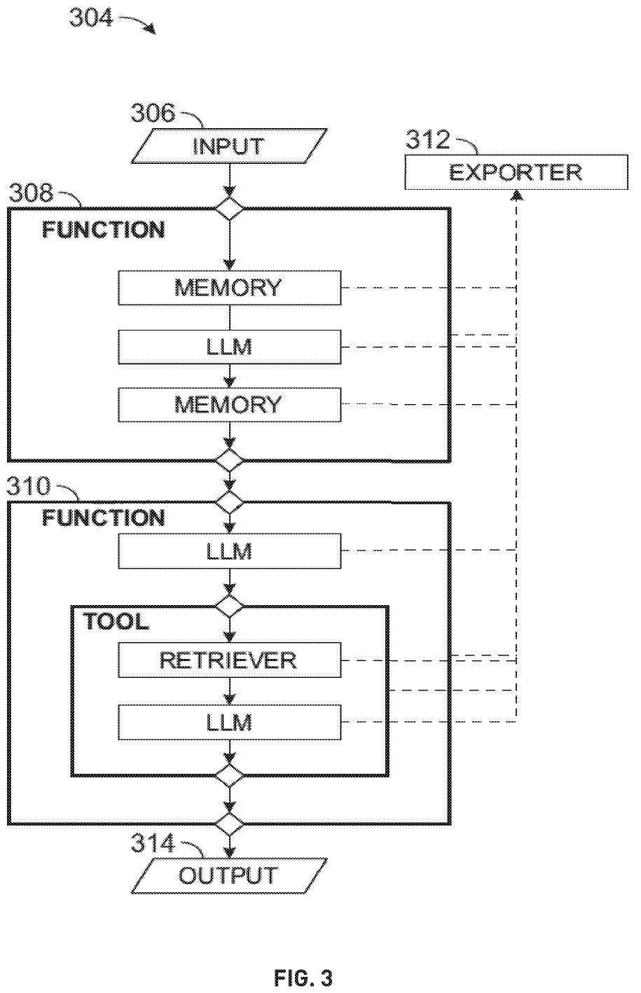

FIG. 3 illustrates an instrumentation data generation system 304, according to at least some embodiments of the present disclosure. Specifically, FIG. 3 illustrates the instrumentation data generation system 304 that demonstrates how the AI agent system 104 processes and standardizes data from multiple AI agent workflows regardless of their underlying framework implementations. This instrumentation data generation system 304 represents a component of the offline inference performance analysis capabilities, showing the flow of data from initial input 306 through various agent workflow components to final output 314, while simultaneously generating standardized instrumentation data through the exporter component 312.

The input 306 represents the starting point where user queries and/or evaluation datasets enter the instrumentation data generation system 304. This input may contain various types of requests that need to be processed by AI agent workflows, similar to how the API server 114 described in FIG. 1 receives requests from developers seeking to analyze their agent workflows. The input 306 feeds into the standardized processing pipeline that enables framework-agnostic analysis of agent behavior across different implementation approaches.

The first AI agent workflow 308 demonstrates one possible agent implementation that includes memory components, language model 118 integration, and additional memory management capabilities. This first AI agent workflow 308 represents how agents built in frameworks such as LangChain or LlamaIndex may be structured, with memory components handling conversation history and context management, while the language model 118 component processes reasoning and response generation tasks. The standardized interface approach allows the system to instrument this workflow regardless of its specific framework implementation.

The second AI agent workflow 310 illustrates an alternative agent architecture that incorporates language model 118 capabilities, tool integrations, retriever component 120 functionality, and additional language model 118 processing stages. This second AI agent workflow 310 demonstrates the flexibility of the instrumentation system to handle diverse agent implementations, including those that utilize retrieval-augmented generation patterns through the retriever component 120, multi-step reasoning processes, and complex tool interaction sequences that may span multiple framework boundaries.

The first AI agent workflow 308 and second AI agent workflow 310 may be built using different underlying frameworks to demonstrate the system's framework-agnostic capabilities. For example, the first AI agent workflow 308 might be implemented using LangChain while the second AI agent workflow 310 could be built using LlamaIndex or CrewAI. The architectural differences between these workflows illustrate the diversity of agent implementations that the AI agent system can support. The second AI agent workflow 310 includes both retriever component 120 functionality and multiple language model 118 processing stages because it may implement a retrieval-augmented generation pattern where the second AI agent workflow 310 needs to search external knowledge bases or vector databases to enhance its responses with contextual information. In contrast, the first AI agent workflow 308 focuses on memory-based processing without external retrieval, representing a simpler conversational agent that relies primarily on conversation history and context management through its memory components. This diversity in architectural patterns demonstrates how the instrumentation data generation system 304 can standardize and analyze performance across different agent implementations regardless of whether they utilize retrieval operations, multiple reasoning steps, or varying combinations of tools and frameworks.

The connection between the first AI agent workflow 308 and second AI agent workflow 310 through the intermediate processing stages shows how the instrumentation data generation system 304 maintains data flow and context across different agent implementations. This interconnection enables the profiler component 112 and evaluation system 106 described in FIG. 1 to collect comprehensive execution traces that capture end-to-end workflow execution data, including function ancestry information and hierarchical relationships between workflow components as they transition between different agent implementations.

The exporter component 312 plays a role in the instrumentation data generation system 304 by extracting standardized metadata from the executing workflows and converting framework-specific events into the unified intermediate step stream format. This exporter component 312 implements the custom callback handlers that intercept framework invocations including language model 118 calls, tool calls, and retriever component 120 operations, extracting relevant metadata such as input data, output data, token usage, and execution timestamps from each intercepted invocation and normalizing this data across different frameworks.

The data flow from both agent workflows toward the exporter component 312 demonstrates how the instrumentation data generation system 304 collects performance and behavioral data from multiple concurrent or sequential agent executions. The exporter component 312 receives events from functions publishing normalized metadata to the intermediate step stream, appends hierarchy metadata including parent function calls and ancestry information to each event, and maintains the comprehensive ledger of actions taken by the agent workflows during processing that enables the advanced profiling capabilities described in the system architecture.

The output 314 represents the final stage where processed results from the agent workflows are delivered to users or downstream systems, while the exporter component 312 simultaneously generates standardized instrumentation data that feeds into the telemetry component 124 and observability platform 126 infrastructure shown in FIG. 1. This dual output approach ensures that agent workflows can continue to operate normally while providing comprehensive performance monitoring and analysis capabilities.

The standardized format generation shown through the exporter component 312 enables the cross-framework observability capabilities where AI agent workflows built in one framework can be visualized using tools associated with different frameworks. This standardization process ensures that LM events, tool events, and other workflow events appear identical regardless of their originating framework, supporting the unified analysis capabilities that distinguish this system from framework-specific solutions.

The instrumentation data generation system 304 shown in FIG. 3 provides the data collection and normalization capabilities that enable the profiling algorithms implemented by the profiler component 112, including latency analysis across different parts of agent workflows, nested bottleneck analysis using function ancestry tracking, concurrency analysis for identifying regions of high concurrency in workflow executions, and token efficiency measurements that examine input token versus completion token ratios across different workflow stages.

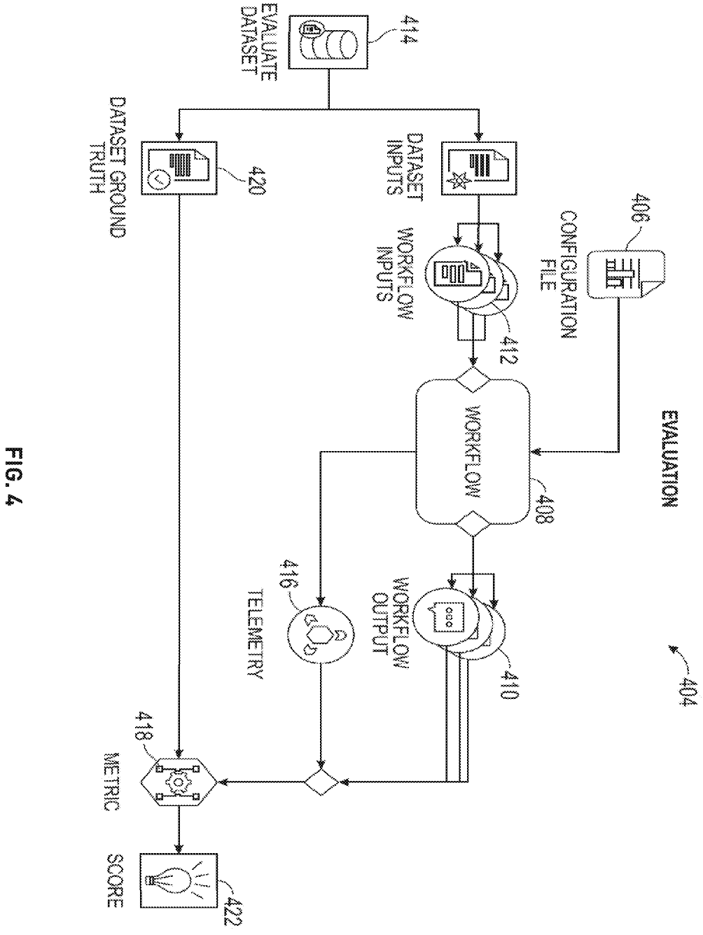

FIG. 4 illustrates an evaluation system 404, according to at least some embodiments of the present disclosure. Specifically, FIG. 4 illustrates the evaluation system 404 that demonstrates how the AI agent system 104 processes and evaluates AI agent workflows 116 through a comprehensive offline analysis approach. This evaluation system 404 represents the evaluation capabilities that enable developers to assess both the performance characteristics and behavioral patterns of their agent implementations across different frameworks. The evaluation system 404 provides a standardized methodology for analyzing agent workflows regardless of their underlying implementation complexity or framework diversity.

The configuration file 406 serves as the component that defines the parameters and settings for the evaluation process. This configuration file 406 may specify which evaluation metrics should be applied, what concurrency levels should be tested during the analysis, and how the evaluation dataset should be processed. The configuration file 406 enables developers to customize their evaluation approach while maintaining consistency across different evaluation runs and allowing for reproducible analysis results that can be compared across different agent implementations.

The AI agent workflow 408 represents the target system being evaluated, which may encompass any combination of agents, tools, and framework implementations that have been instrumented by the AI agent system. The AI agent workflow 408 receives input 412 from the evaluation process and generates output 410 that will be analyzed for performance and behavioral characteristics. This AI agent workflow 408 (e.g., the AI agent workflows 116) may contain the complex multi-framework agent implementations described in previous figures, including ReAct agents, retrieval systems, and various tool integrations that operate across different agent frameworks.

The evaluation dataset 414 provides the standardized inputs that are used to systematically test the AI agent workflow 408 across various scenarios and conditions. This evaluation dataset 414 may contain representative queries, requests, or tasks that reflect real-world usage patterns and enable comprehensive testing of agent capabilities. The evaluation dataset 414 works in conjunction with the input 412 component to ensure that agent workflows are tested with consistent and meaningful data that can reveal performance patterns and behavioral insights.

During the evaluation process, the evaluation system 404 collects instrumentation data 416 from the executing AI agent workflow 408. This instrumentation data 416 represents the comprehensive telemetry and execution traces that are gathered through the custom callback handlers and intermediate step stream mechanisms described in previous figures. The instrumentation data 416 includes timing information, token usage statistics, function ancestry data, and other performance-related metadata that enables detailed analysis of agent behavior during execution.

In some examples, during the evaluation process, the evaluation system 404 collects instrumentation data 416 from the executing AI agent workflow 408 through a multi-layered approach that operates transparently during workflow execution. The collection process begins when developers submit their agent workflows to the system through various upload mechanisms, including direct code submission via REST API endpoints, configuration file uploads using YAML-based workflow definitions, or through integration with existing development environments where the API server can access workflow repositories or containerized agent implementations. The system supports both ZIP file uploads containing complete workflow implementations and direct integration with version control systems, enabling seamless incorporation of existing agent development workflows without requiring significant modifications to developers' existing codebases.

The instrumentation data 416 collection process relies on both manual and automated framework detection capabilities to identify which agent frameworks are being used in submitted workflows. For manual detection, developers can explicitly declare the frameworks they are using through configuration parameters or metadata tags when submitting their workflows, such as specifying LangChain, LlamaIndex, CrewAI, Semantic Kernel, or other supported frameworks. The system provides standardized configuration templates that allow developers to indicate which frameworks power different components of their multi-framework agent implementations, enabling precise control over the instrumentation process. This manual approach ensures that developers can specify exactly which frameworks require monitoring and can provide additional context about framework-specific configurations that may affect data collection.

For automated framework detection, the system employs sophisticated code analysis techniques that inspect source code at build time to identify undeclared agent frameworks without requiring explicit developer input. This automated detection process analyzes code structure, library imports, function signatures, and dependency declarations to infer which LLM frameworks are being used even when not explicitly declared by developers. The system uses pattern matching algorithms that recognize framework-specific coding patterns, API calls, and data structures characteristic of different agent frameworks, such as identifying LangChain's callback mechanisms, LlamaIndex's service context patterns, or CrewAI's agent instantiation methods. Once frameworks are identified through either manual declaration or automated discovery, the system coordinates the registration of appropriate custom callback handlers for each detected framework, enabling comprehensive instrumentation and data collection capabilities across heterogeneous agent implementations, ensuring that instrumentation data 416 captures complete execution traces regardless of the underlying framework complexity.

The metric generation component 418 processes the collected instrumentation data 416 to produce quantitative assessments of agent performance and behavior through algorithmic analysis that operates across multiple dimensions of workflow execution. This metric generation component 418 implements latency analysis algorithms that can dissect timing patterns at granular levels, measuring individual LLM inference times, tool execution durations, and end-to-end workflow completion times across different concurrency scenarios. The metric generation component 418 transforms the raw execution data into meaningful performance indicators that developers can use to understand and improve their agent implementations. For example, when analyzing a multi-agent workflow that processes customer support tickets, the metric generation component 418 might identify that while the initial ticket classification LLM call averages 1.2 seconds under single-request conditions, this same operation degrades to 3.8 seconds when processing 8 concurrent requests, indicating potential resource contention that requires infrastructure scaling or request throttling strategies.

The bottleneck identification capabilities of the metric generation component 418 leverage the hierarchical function ancestry data captured through the intermediate step stream to pinpoint performance degradation at unprecedented granular levels across framework boundaries. By analyzing execution timestamps in conjunction with function call hierarchies, the metric generation component 418 can identify that within a complex RAG-enhanced agent workflow, the specific bottleneck occurs not in the primary LLM reasoning step, but in a nested retriever component that performs vector similarity searches within a LlamaIndex tool called by a LangChain parent agent. For instance, the analysis might reveal that 73% of total workflow latency stems from a single Pinecone vector database query operation buried three function calls deep in the execution tree, enabling developers to target optimization efforts precisely rather than attempting broad-spectrum performance improvements.

The concurrency analysis algorithms implemented by the metric generation component 418 automatically detect workflow execution patterns that exhibit high concurrent processing regions and correlate these with LLM inference latency spikes to provide deployment optimization insights. These algorithms can identify scenarios where certain agent functions naturally parallelize tool calls or spawn concurrent sub-agents, measuring how hardware limitations manifest during these peak concurrent periods. Additionally, the token efficiency analysis generates standardized metrics that track prompt token versus completion token ratios across different stages of agent workflows, enabling developers to identify opportunities for prompt optimization, response caching, or model selection adjustments that could significantly reduce both inference costs and latency while maintaining output quality.

The ground truth data 420 component provides reference information against which the AI agent workflow 408 output can be compared for accuracy and correctness evaluation. This ground truth data 420 enables traditional evaluation metrics such as accuracy, relevance, and groundedness assessments that complement the performance-focused analysis provided by the instrumentation data 416. The integration of ground truth data 420 with performance metrics creates a comprehensive evaluation approach that addresses both functional correctness and operational efficiency.

The score component 422 represents the final evaluation results that combine insights from the performance analysis and traditional accuracy assessments. This score component 422 may generate standardized reports that include the various metrics produced by the metric generation component 418, providing developers with actionable insights about their agent workflow performance. The score component 422 enables developers to identify optimization opportunities, understand scaling behavior, and make informed decisions about deployment configurations.

For example, the score component 422 the score component 422 serves as the comprehensive reporting engine that synthesizes all performance analysis data into actionable intelligence for developers. Namely, when analyzing a multi-framework agent workflow that uses both LangChain and LlamaIndex components, the score component 422 may generate a detailed performance report showing that the LangChain-based retrieval component contributes 73% of the total workflow latency during concurrent request processing, while the LlamaIndex-based reasoning component maintains consistent sub-second response times across all concurrency levels. These reports may include specific recommendations such as "Consider implementing caching for the retrieval component" or "Current bottleneck at 8 concurrent users suggests infrastructure scaling at this threshold."

The score component 422 may also generate comparative analysis reports that help developers understand how different implementation choices affect performance metrics. For instance, it might produce a report showing that switching from a langchain-based tool to a CrewAI-based equivalent for the same function reduces average token usage by 23% while maintaining the same accuracy score, or that certain prompt patterns identified across multiple framework boundaries result in 15% higher completion token generation. These insights enable developers to make data-driven decisions about which frameworks and configurations to use for specific components of their agent workflows.

Additionally, the score component 422 may create deployment optimization reports that combine performance efficiency metrics with traditional accuracy assessments to provide holistic recommendations. These reports might indicate that while one configuration achieves 95% accuracy, an alternative approach achieves 92% accuracy but with 40% lower latency and 30% reduced token consumption, enabling developers to make informed trade-offs based on their specific deployment requirements and cost constraints. The standardized format ensures that these insights can be integrated into existing development workflows and decision-making processes across different teams and frameworks.

The evaluation system 404 demonstrates the integration between performance analysis and traditional evaluation approaches, showing how the AI agent system can provide comprehensive insights into both the functional and operational characteristics of agent workflows. The evaluation system 404 enables offline analysis that can simulate multiple concurrency levels and user load patterns while maintaining the standardized data collection and analysis capabilities that work across different agent framework implementations.

The flow from the evaluation dataset 414 through the AI agent workflow 408 to the final score component 422 illustrates the systematic approach that enables developers to obtain reproducible and comparable evaluation results regardless of the complexity or framework diversity of their agent implementations. This evaluation methodology supports the toolkit's goal of providing comprehensive agent analysis capabilities that extend beyond traditional accuracy-focused evaluation to include the performance optimization insights that are important for production deployment of AI agent systems.

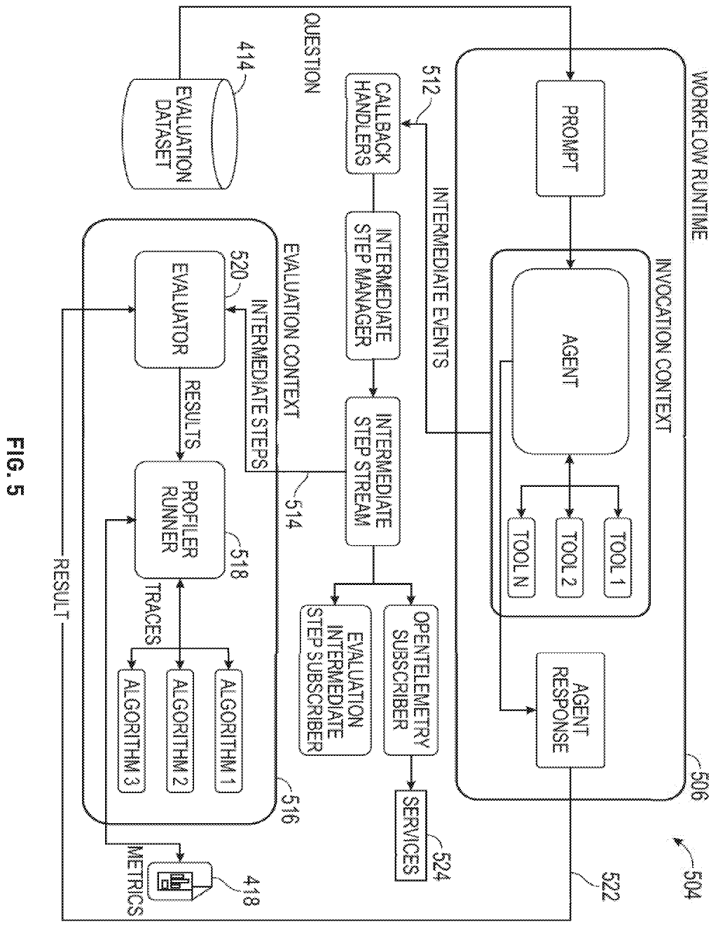

FIG. 5 illustrates an evaluation system 504, according to at least some embodiments of the present disclosure. Specifically, FIG. 5 illustrates the evaluation system 504 that demonstrates the comprehensive instrumentation and analysis capabilities of the AI agent system 104 for profiling and evaluating AI agent workflows during execution. This evaluation system 504 may represent the integration of real-time data collection, standardized event processing, and algorithmic analysis that enables developers to obtain detailed performance insights and behavioral characteristics from their agent implementations. The evaluation system 504 may provide a unified framework for collecting, processing, and analyzing execution data from AI agent workflows 116 regardless of their underlying framework implementations.

The workflow runtime component may serve as the execution environment where AI agent workflows 506 operate and process user requests. This runtime environment may coordinate the execution of various workflow components including agents, tools, and other processing elements while maintaining comprehensive instrumentation capabilities. The workflow runtime may ensure that all execution events are properly captured and made available for analysis through the integrated monitoring and profiling systems. The invocation context within the workflow runtime component may represent the execution environment and state information that surrounds each workflow execution instance. This context may include session data, user information, configuration parameters, and other contextual elements that influence how the AI agent workflow 506 processes requests and generates responses. The invocation context may provide the necessary environmental information that enables proper interpretation and analysis of execution traces and performance data.

The AI agent workflow 506 may represent the target system being analyzed, which can include any combination of agents, tools, language models, retrievers, and other components implemented across different frameworks. This workflow may execute the core business logic and processing required to handle user queries and generate appropriate responses. The AI agent workflow 506 may be instrumented through the evaluation system 504 to capture comprehensive execution data without requiring modifications to the underlying workflow implementation.

The evaluation dataset 414 may provide reference data and test cases that are used to systematically evaluate workflow performance and behavior of the AI agent workflow 506. This evaluation dataset 414 may include representative inputs, expected outputs, and evaluation criteria that enable consistent and repeatable analysis of workflow implementations. The evaluation dataset may support both automated evaluation processes and manual analysis workflows.

The intermediate events 512 may represent the real-time stream of execution events generated during workflow processing. These intermediate events 512 may include tool invocations, language model calls, data retrieval operations, and other processing steps that occur during workflow execution. The intermediate events 512 may be captured through the instrumentation system and made available for both real-time monitoring and offline analysis purposes.

The services 524 component may represent external or managed services that support the evaluation and analysis process. These services may include observability platforms, data storage systems, analytical processing engines, and other infrastructure components that enable comprehensive workflow analysis. The services 524 may provide scalable processing capabilities that support the evaluation system's analytical requirements.

The callback handlers may implement the instrumentation mechanism that intercepts and captures execution events from the AI agent workflow 506. These handlers may be automatically registered with different framework implementations to ensure comprehensive coverage of workflow execution events. The callback handlers may extract relevant metadata from framework-specific events and convert them into standardized formats that can be processed by the evaluation system 504. The intermediate step manager may coordinate the collection and distribution of execution events from the callback handlers. This manager may receive events from various sources within the workflow execution environment and ensure they are properly formatted and distributed to appropriate subscribers. The intermediate step manager may maintain the integrity and ordering of execution events while supporting multiple concurrent subscribers.

The intermediate step stream may serve as the central data pipeline that distributes standardized execution events to various analysis and monitoring components. This stream may implement a reactive architecture that supports real-time event processing while maintaining historical data for offline analysis. The intermediate step stream may ensure that all execution events are available in a consistent format regardless of their originating framework or component.

The OpenTelemetry subscriber may implement standardized observability data export capabilities that enable integration with external monitoring and visualization platforms. This subscriber may convert the standardized intermediate events into OpenTelemetry-compatible formats that can be consumed by various observability tools and platforms. The OpenTelemetry subscriber may enable cross-platform visibility and monitoring of workflow execution data.

The evaluation intermediate step subscriber may collect execution events specifically for evaluation and analysis purposes. This subscriber may process the intermediate step stream data to prepare it for algorithmic analysis and performance evaluation. The evaluation intermediate step subscriber may filter and aggregate execution events to support the specific requirements of the evaluation algorithms and profiling components.

In some examples, the evaluation context 516 may provide the contextual information and configuration parameters that guide the evaluation process. This context may include evaluation criteria, performance thresholds, analysis parameters, and other settings that determine how execution data should be analyzed and interpreted. The evaluation context 516 may ensure that evaluation results are meaningful and aligned with the specific requirements of the workflow being analyzed.

For example, the evaluation context 516 may contain specific performance threshold parameters such as maximum acceptable latency targets (e.g., "LLM response time must not exceed 2.5 seconds"), concurrency limits for testing (e.g., "evaluate performance at 1, 2, 4, 8, and 16 concurrent users"), and token efficiency benchmarks (e.g., "flag workflows where completion tokens exceed 500 tokens per response"). The context may also specify analysis parameters including which profiling algorithms to apply, such as enabling nested bottleneck analysis for workflows with function call depths greater than 3 levels or activating token pattern analysis for workflows that include retrieval-augmented generation components. Additionally, the evaluation context 516 may define framework-specific settings that determine how different agent implementations should be instrumented and monitored, such as specifying callback handler registration priorities for LangChain versus LlamaIndex components.

The evaluation context 516 may also include workflow-specific configuration parameters that customize the analysis approach based on the type of agent being evaluated. For instance, it may specify that customer service chatbots should be evaluated with emphasis on response time consistency across conversation turns, while code generation agents should prioritize token efficiency and accuracy metrics. The context may define custom evaluation datasets appropriate for different workflow types, establish baseline performance metrics derived from previous evaluation runs, and configure the frequency and scope of profiling data collection. Furthermore, the evaluation context 516 may contain integration settings that determine how evaluation results should be exported to external observability platforms, specify which stakeholders should receive automated performance reports, and define alert thresholds that trigger notifications when performance metrics fall below acceptable ranges.

The intermediate steps 514 may represent the processed and standardized execution data that has been prepared for analysis. These intermediate steps 514 may include normalized representations of tool calls, language model invocations, data retrieval operations, and other workflow execution events. The intermediate steps 514 may maintain temporal ordering and hierarchical relationships that enable comprehensive workflow analysis.

For example, the intermediate steps 514 may contain standardized event data structures that capture specific execution details regardless of the originating framework implementation. When a LangChain-based agent makes an LLM call, the custom callback handlers may extract framework-specific metadata such as langchain.schema.messages.AIMessage objects with nested content fields and timing data in LangChain's proprietary format. Simultaneously, when a LlamaIndex agent performs a similar LLM operation, the callback handlers may capture metadata in LlamaIndex's native format, which could include llama_index.core.base.llms.types.ChatMessage objects with different field structures. The intermediate steps 514 may transform both of these disparate data structures into a unified format that includes standardized fields such as input_text, output_text, prompt_tokens, completion_tokens, latency_ms, timestamp_iso, and function_ancestry, ensuring that LLM calls appear identical regardless of whether they originated from LangChain, LlamaIndex, CrewAI, or any other supported framework.

The intermediate steps 514 may also include hierarchical metadata that maintains complete execution ancestry chains across framework boundaries. For instance, if an agent workflow begins with a LangChain ReAct agent that calls a LlamaIndex retriever tool, which subsequently invokes a CrewAI sub-agent, the intermediate steps 514 may maintain a complete ancestry chain showing how langchain_react_agent.execute() called llamaindex_retriever.search() which then called crewai_specialist.analyze(). Each event in the intermediate steps 514 may contain standardized metadata fields including execution timestamps (e.g., start_time: 2025-01-15T14:30:25.123Z), token utilization metrics (e.g., prompt_tokens: 1247, completion_tokens: 389), performance indicators (e.g., execution_duration_ms: 2340), and unique identifiers that enable downstream analysis algorithms to reconstruct complete workflow execution timelines and identify performance bottlenecks at any level of the execution hierarchy.

Additionally, the intermediate steps 514 may support multiple event types including function start events, function end events, tool invocation events, LLM request events, and retrieval operation events, each with their own specialized metadata fields that capture the specific characteristics relevant to that event type. The temporal ordering preserved within the intermediate steps 514 may enable analysis capabilities such as identifying concurrent execution regions, measuring end-to-end latency across nested function calls, and tracking token efficiency patterns across different stages of agent workflow execution, providing developers with unprecedented visibility into the behavioral characteristics of their multi-framework agent implementations.

The evaluator component 520 may implement the evaluation logic that assesses workflow performance, accuracy, and other behavioral characteristics. This evaluator component 520 may apply various evaluation metrics and algorithms to the collected execution data to generate quantitative assessments of workflow behavior. The evaluator component 520 may support multiple evaluation methodologies and can be configured to assess different aspects of workflow performance.

For example, the evaluator component 520 may implement sophisticated evaluation logic that operates on the standardized intermediate steps 514 and evaluation context 516 to generate comprehensive assessments of agent workflow behavior across multiple dimensions. This evaluator component 520 may apply diverse evaluation methodologies including traditional accuracy metrics such as groundedness and relevance assessments, as well as behavioral performance metrics that analyze workflow efficiency and operational characteristics. For example, the evaluator component 520 may implement algorithms that compare agent outputs against ground truth datasets from the evaluation dataset to calculate precision and recall scores, while simultaneously analyzing the intermediate step data to assess response consistency across different input variations. The evaluator component 520 may support configurable evaluation criteria where developers can specify custom evaluation thresholds, such as requiring accuracy scores above 85% for production deployment or establishing maximum acceptable response times for real-time applications.

The evaluator component 520 may also integrate multiple evaluation algorithms that can operate concurrently on the same execution data to provide comprehensive workflow assessment. For instance, the evaluator component 520 may simultaneously run accuracy evaluation algorithms that compare generated outputs to expected results, relevance evaluation algorithms that assess whether responses appropriately address user queries, and safety evaluation algorithms that detect potentially harmful or inappropriate content. The evaluator component 520 may support domain-specific evaluation methodologies, such as implementing specialized code evaluation algorithms for agent workflows that generate programming solutions, mathematical validation algorithms for agents that solve computational problems, or fact-checking algorithms for agents that provide informational responses. These evaluation algorithms may be dynamically selected based on the workflow type and evaluation context 516 configuration, allowing the same evaluator component 520 to assess diverse agent implementations using appropriate evaluation criteria.

Furthermore, the evaluator component 520 may generate quantitative assessments that combine multiple evaluation metrics into comprehensive scores and detailed evaluation reports. The component may implement weighted scoring systems where different evaluation criteria contribute proportionally to overall workflow assessment scores, enabling developers to emphasize specific performance characteristics such as prioritizing accuracy over speed for research applications or balancing response quality with latency for customer service implementations. The evaluator component 520 may also support comparative evaluation capabilities that assess multiple workflow configurations or agent implementations against the same evaluation dataset, generating detailed comparative analysis reports that highlight performance differences and optimization opportunities across different agent architectures or parameter configurations.

The profiler component 518 may implement specialized analysis algorithms that focus on performance characteristics, bottleneck identification, and resource utilization patterns. This component may analyze execution traces to identify latency issues, concurrency limitations, token usage patterns, and other performance-related insights. The profiler component 518 may generate detailed performance reports including performance efficiency metrics that help developers understand and optimize their workflow implementations. The algorithm components may represent the various analytical algorithms that process execution data to generate insights and performance efficiency metrics. These algorithms may include latency analysis routines, bottleneck detection algorithms, concurrency analysis methods, and token efficiency calculations. The algorithm components may operate on the standardized execution data to produce meaningful performance and behavioral insights.

The traces may represent the structured execution data that has been processed and prepared for algorithmic analysis. These traces may include comprehensive information about workflow execution paths, timing data, resource utilization, and component interactions. The traces may maintain the hierarchical and temporal relationships between execution events that enable detailed workflow analysis.

The metrics component may collect and aggregate the quantitative measurements and assessments generated by the evaluation and profiling algorithms. This component may calculate summary statistics, trend analysis, and comparative measurements that provide insight into workflow performance and behavior as the performance efficiency metrics. The metrics component may support both real-time monitoring and historical analysis of workflow characteristics.

For example, the performance efficiency metrics may encompass a comprehensive suite of analytical measurements that provide unprecedented visibility into AI agent workflow behavior across different operational dimensions. The latency analysis metrics may examine language model inference times at granular levels, measuring individual LLM call durations, tool execution latencies, and complete workflow runtime statistics across various concurrency scenarios. For example, when analyzing a multi-agent customer service workflow, the latency analysis metrics might reveal that the initial query classification LLM call averages 1.8 seconds under single-request conditions but degrades to 4.2 seconds when processing 12 concurrent requests, while the downstream knowledge retrieval component maintains consistent sub-second performance regardless of concurrency levels. These metrics may also track end-to-end workflow completion times, identifying scenarios where a workflow that typically completes in 8.5 seconds under normal load extends to 23.7 seconds during peak concurrent usage periods.

The bottleneck analysis metrics may leverage the hierarchical function ancestry tracking capabilities to identify performance degradation points with surgical precision across framework boundaries. By analyzing execution timestamps in conjunction with function call hierarchies, these metrics can isolate bottlenecks to specific nested components within complex multi-framework workflows. For instance, the bottleneck analysis might determine that within a retrieval-augmented generation workflow, 68% of total execution latency stems from a single Pinecone vector database query operation embedded four function calls deep in a LlamaIndex retriever tool that is called by a LangChain parent agent. The metrics may provide detailed breakdown showing that while the primary reasoning LLM calls complete in an average of 2.1 seconds, the nested vector similarity search operation requires 12.8 seconds, creating a clear optimization target for developers seeking to improve overall workflow performance.

The concurrency analysis metrics may automatically identify execution patterns where agent workflows exhibit natural parallelization opportunities and correlate these with hardware resource utilization during peak concurrent processing periods. These metrics can distinguish between workflow regions that benefit from concurrent execution versus those that create resource contention bottlenecks. Additionally, the token efficiency metrics may generate detailed analyses of prompt token versus completion token utilization patterns, enabling developers to identify optimization opportunities such as prompt compression strategies or response length optimization targets. For example, the token efficiency analysis might reveal that a code generation workflow consistently uses 1,247 prompt tokens to generate an average of 389 completion tokens, but certain prompt patterns result in significantly higher completion token generation, suggesting opportunities for prompt refinement or model parameter adjustments that could reduce both inference costs and latency while maintaining output quality.

The results 522 component may consolidate and present the outcomes of the evaluation and profiling analysis in formats suitable for developer consumption. These results may include performance reports, behavioral insights, optimization recommendations, and comparative analysis across different workflow configurations or implementations. The results 522 may be formatted to support both automated processing and human interpretation.

The evaluation system 504 may coordinate the interaction between all these components to provide a comprehensive analysis framework that operates transparently during workflow execution. The system may automatically discover framework implementations, register appropriate instrumentation handlers, collect and normalize execution data, apply analytical algorithms, and generate actionable insights that help developers understand and optimize their AI agent workflows across different framework implementations and deployment scenarios.

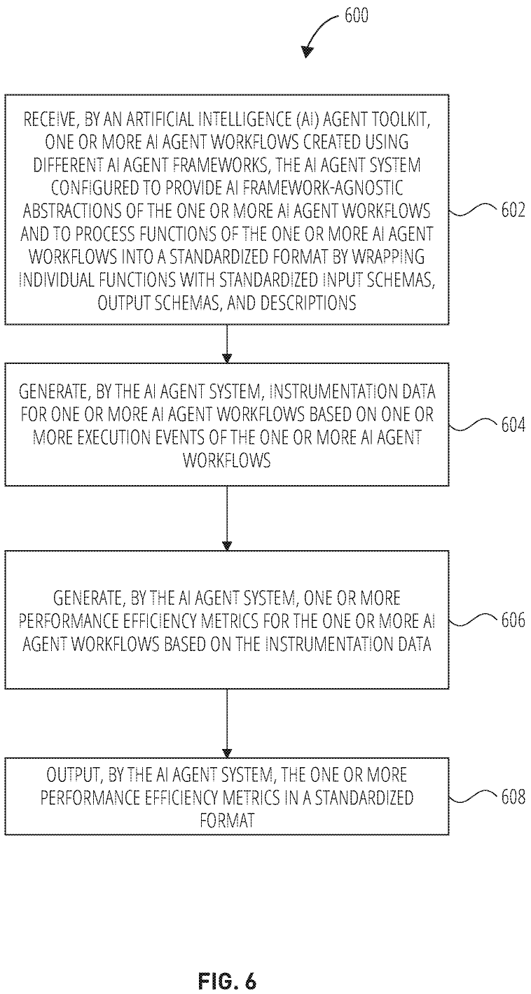

Now referring to FIG. 6, each block (or operation) of method 600, described herein, comprises a computing process that may be performed using any combination of hardware, firmware, and/or software. For instance, various functions may be carried out using one or more processors executing instructions stored in one or more memories. The method 600 may also be embodied as computer-usable instructions stored on computer storage media. The method 600 may be provided by a standalone application, a service or hosted service (standalone or in combination with another hosted service), as a microservice via an application programming interface (API), or a plug-in to another product, to name a few. In addition, the method 600 is described, by way of example, with respect to the AI agent system 104 of FIG. 1. However, this method 600 may additionally or alternatively be executed by any one system, or any combination of systems, including, but not limited to, those described herein. Specifically, the method 600 can be performed by any component shown in FIG. 1.

At operation 602, the AI agent system 104 receives one or more AI agent workflows 116 created using different AI agent frameworks. The AI agent system 104 is configured to provide AI framework-agnostic abstractions of the AI agent workflows and to process functions of the AI agent workflows 116 into a standardized format by wrapping individual functions with standardized input schemas, output schemas, and descriptions. This operation enables the system to work with agent workflows regardless of whether they are implemented using, for example, LangChain, LlamaIndex, CrewAI, Semantic Kernel, or other agent frameworks. The standardization process involves inspecting source code to identify undeclared agent frameworks, automatically discovering language model frameworks used in function definitions, and registering custom callback handlers for each identified framework to enable comprehensive instrumentation across heterogeneous agent implementations.

At operation 604, the AI agent system 104 generates instrumentation data 416 for the AI agent workflows based on execution events of the workflows. This instrumentation data 416 includes execution event data captured through custom callback handlers containing timestamps, input data, output data, and token usage for each language model call, tool call, and function call. The AI agent system 104 also captures function ancestry information that tracks which functions called other functions and maintains hierarchical relationships between workflow components. The instrumentation process involves intercepting framework invocations across all supported frameworks, extracting relevant metadata, normalizing the extracted metadata across different frameworks into a unified data model, and publishing the normalized metadata to an intermediate step stream that provides a standardized ledger of all actions taken by the agentic system during workflow execution.

At operation 606, the AI agent system 104 generates performance efficiency metrics for the AI agent workflows 116 based on the instrumentation data 416 collected in operation 604. These performance efficiency metrics may include latency analysis metrics that measure language model latency and end-to-end workflow runtimes across different parts of an AI agent workflow, bottleneck analysis metrics that identify certain functions and specific language models or tool components causing latency using function ancestry and timestamps, concurrency analysis metrics that represent regions of high concurrency in AI agent workflow executions and estimate language model inference latency during peak usage periods, and token efficiency metrics that analyze input token versus completion token ratios and identify token usage patterns at various stages of the workflow. The AI agent system 104 executes the workflows across multiple concurrency levels, simulates user load patterns by varying the number of simultaneous requests, and applies custom profiling algorithms to identify performance bottlenecks and behavioral characteristics that were previously impossible to obtain across multi-framework agent architectures.

At operation 608, the AI agent system 104 outputs the performance efficiency metrics in a standardized format. This standardized output enables developers to identify workflow performance characteristics and behavioral insights through comprehensive reports that include performance efficiency metrics, bottleneck analysis reports, and token utilization patterns. The standardized format ensures compatibility with various development tools and facilitates integration with existing development workflows, while also supporting export to observability platforms using OpenTelemetry-compatible formats and enabling cross-framework observability where AI agent workflows built in one framework can be visualized using tools associated with different frameworks.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA’s OMNIVERSE and/or another platform, system, or service that uses USD or OpenUSD data types), systems implemented using an edge device, systems using or deploying one or more inference microservices, systems incorporating one or more machine learning models deployed in a service or microservice along with an OS-level virtualization package; systems incorporating one or more virtual machines (VMs), systems for performing synthetic data generation operations (e.g., using one or more neural rendering fields (NERFs), Gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models (e.g., the AI agent workflows 116), such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with a large number of learnable network parameters (weights and biases) – such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs – such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not need task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model-alignment techniques. For example, in some embodiments, guardrails may be implemented to identify improper or undesired inputs (e.g., prompts) and/or outputs of the models. In doing so, the system may use the guardrails and/or other model-alignment techniques to either prevent a particular undesired input from being processed using the LLMs/SLMs/VLMs/MMLMs/etc., and/or preventing the output or presentation (e.g., display, audio output, etc.) of information generated using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MSLMs/MLMs/MMLMs/etc. may be configured to access or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., third-party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires or benefits from a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

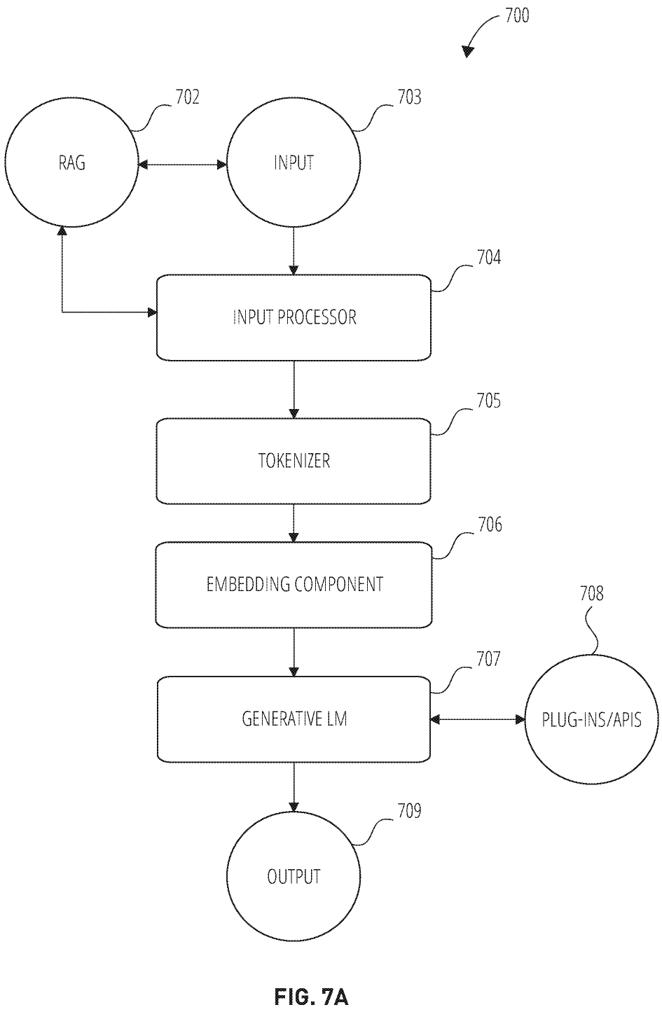

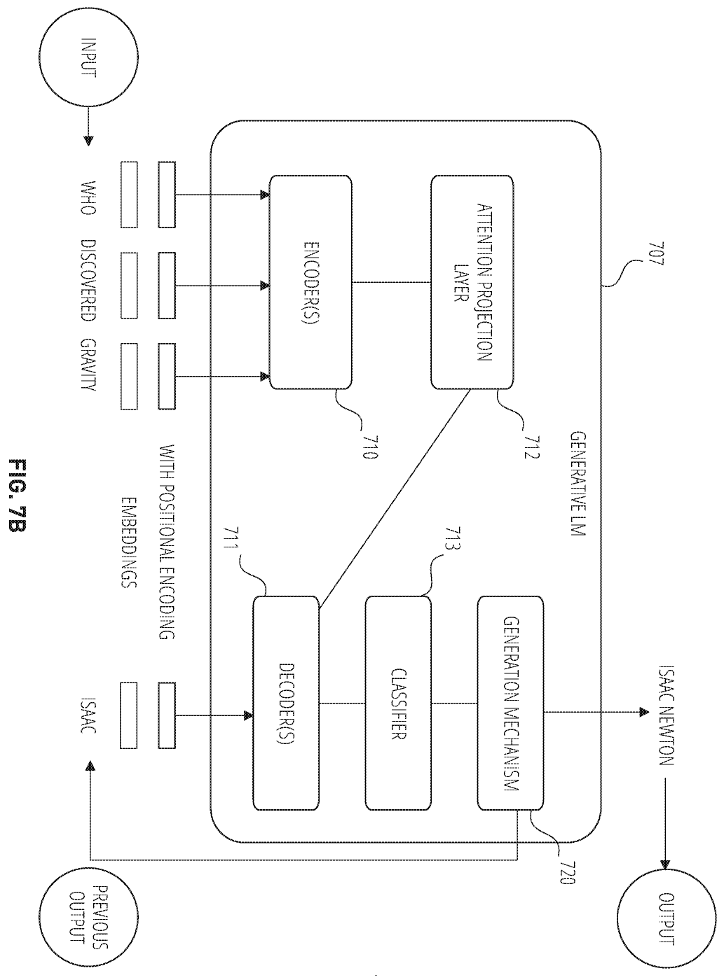

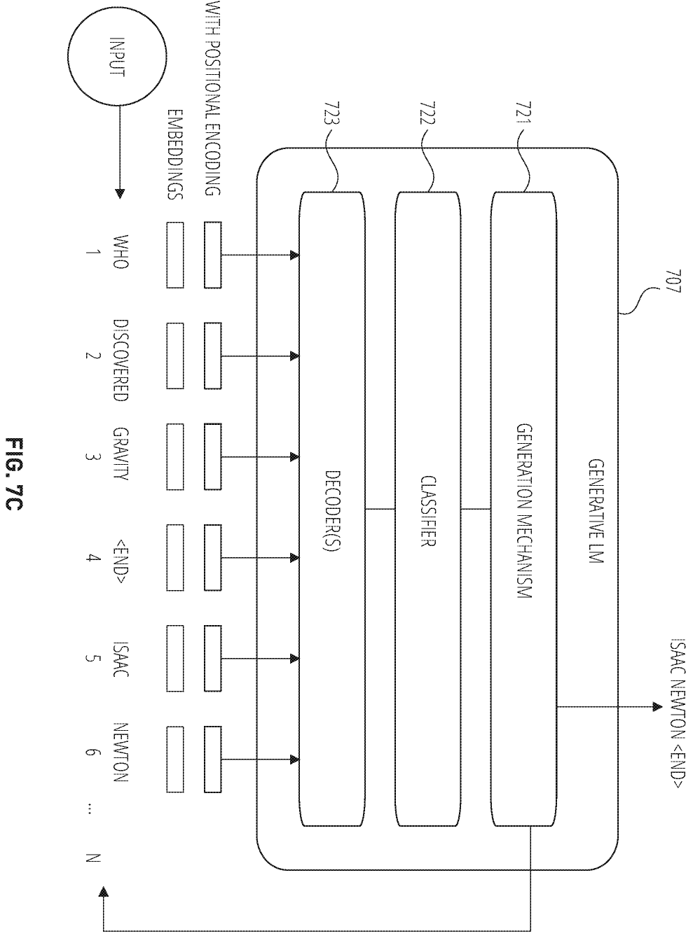

For example, and with reference to FIG. 7A, the generative LM 707 can access external resources through plug-ins/APIs 708 to enhance its capabilities beyond its internal knowledge base. When processing inputs, the generative LM 707 can intelligently determine when to utilize specific plug-ins/APIs 708 based on the requirements of the task. For example, when generating code, the generative LM 707 may access code execution environments through plug-ins/APIs 708 to test and validate solutions before providing them as output 709. The system enables coordinated use of multiple plug-ins/APIs 708 during generation, where the generative LM 707 can sequence different verification tools based on the specific requirements of the task. For instance, when solving mathematical problems, the generative LM 707 may first use symbolic computation plug-ins to verify equations, then access mathematical proof validation tools to check logical consistency, and finally employ formatting plug-ins to ensure proper mathematical notation in the output 709. This layered verification approach allows the generative LM 707 to produce outputs that are not only technically correct but also properly formatted and documented.

The plug-ins/APIs 708 integration is particularly valuable for verification tasks, as it allows the generative LM 707 to dynamically validate its outputs using domain-specific tools. For example, when generating code, the generative LM 707 can use syntax checkers, linters, and runtime environments accessed through plug-ins/APIs 708 to verify correctness, style, and execution behavior. The system can recursively apply these verification tools, using the feedback to refine the output 709 until it meets the required quality standards.

In some embodiments, multiple language models (e.g., LLMs/SLMs/VLMs/MMLMs/etc.) and/or multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models, e.g., language models with different architectures and language models trained on different (e.g., updated) corpora of data, may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example non-limiting embodiments, the same language model may be asked to provide output corresponding to a different role, perspective, character, or having a different base of knowledge, etc., as defined by a supplied prompt.

In any one of such embodiments, the output of two or more (e.g., each) language models, two or more versions of at least one language model, two or more instanced agents of at least one language model, and/or two or more prompts provided to at least one language model may be further processed, e.g., aggregated, compared or filtered against, or used to determine (and provide) a consensus response. In one or more embodiments, the output from one language model—or version, instance, or agent—may be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 7A is a block diagram of an example generative LLM system, generative LLM system 700, suitable for use in implementing at least some embodiments of the present disclosure. In the example illustrated in FIG. 7A, the generative LLM system 700 includes a retrieval augmented generation (RAG) component 702, an input processor 704, a tokenizer 705, an embedding component 706, a generative LM 707 (which may include an LLM, a SLM, a VLM, a multi-modal LM, etc.), and plug-ins/APIs 508.

At a high level, the input processor 704 may receive an input 703 comprising text and/or other types of input data (e.g., audio data, video data, image data, sensor data (e.g., LiDAR, RADAR, ultrasonic, etc.), 3D design data, CAD data, universal scene descriptor (USD) data – such as OpenUSD, etc.), depending on the architecture of the generative LM 707 (e.g., LLM/SLM/VLM/MMLM/etc.). In some embodiments, the input 703 includes plain text in the form of one or more sentences, paragraphs, and/or documents. Additionally, or alternatively, the input 703 may include numerical sequences, precomputed embeddings (e.g., word or sentence embeddings), and/or structured data (e.g., in tabular formats, JSON, or XML). In some implementations in which the generative LM 707 is capable of processing multi-modal inputs, the input 703 may combine text (or may omit text) with image data, audio data, video data, design data, USD data, and/or other types of input data, such as but not limited to those described herein. Taking raw input text as an example, the input processor 704 may prepare raw input text in various ways. For example, the input processor 704 may perform various types of text filtering to remove noise (e.g., special characters, punctuation, HTML tags, stop words, portions of an image(s), portions of audio, etc.) from relevant textual content. In an example involving stop words (common words that tend to carry little semantic meaning), the input processor 704 may remove stop words to reduce noise and focus the generative LM 707 on more meaningful content. The input processor 704 may apply text normalization, for example, by converting all characters to lowercase, removing accents, and/or handling special cases like contractions or abbreviations to ensure consistency. These are just a few examples, and other types of input processing may be applied.

In some embodiments, a RAG component 702 (which may include one or more RAG models, and/or may be performed using the generative LM 707 itself) may be used to retrieve additional information to be used as part of the input 703 or prompt. The RAG component 702 may be used to enhance the input to the LLM/SLM/VLM/MMLM/etc. with external knowledge, so that answers to specific questions or queries or requests are more relevant—such as in a case where specific knowledge is involved. The RAG component 702 may fetch this additional information (e.g., grounding information, such as grounding text/image/video/audio/USD/CAD/etc.) from one or more external sources, which can then be fed to the LLM/SLM/VLM/MMLM/etc. along with the prompt to improve the accuracy of the responses or outputs of the model.

For example, in some embodiments, the input 703 may be generated using the query or input to the model (e.g., a question, a request, etc.) in addition to data retrieved using the RAG component 702. In some embodiments, the input processor 704 may analyze the input 703 and communicate with the RAG component 702 (or the RAG component 702 may be part of the input processor 704, in embodiments) in order to identify relevant text and/or other data to provide to the generative LM 707 as additional context or sources of information from which to identify the response, answer, or output 709, generally. For example, where the input 703 indicates that the user is interested in a desired tire pressure for a particular make and model of vehicle, the RAG component 702 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 702 may retrieve a prior stored conversation history—or at least a summary thereof—and include the prior conversation history along with the current ask/request as part of the input 703 to the generative LM 707.

For example, in some embodiments, the input 703 may be generated using the query or input to the model (e.g., a question, a request, etc.) in addition to data retrieved using the RAG component 702. This integration creates a comprehensive input package that combines the original task requirements with contextually relevant information for evaluation. The input 703 can take various forms, such as a structured data object containing multiple elements: the original query or task description, verification criteria for the AI agent workflows 116, and relevant reference information retrieved by the RAG component 702. When processing a task like "Implement a binary search tree insertion algorithm," the input 703 can include not only this request but also relevant documentation, test cases, and performance metrics that the AI agent workflows 116 will use to assess the generated solution.

The input processor 704 analyzes this enriched input package and communicates with the RAG component 702 to identify additional verification resources needed for comprehensive evaluation. The input processor 704 may analyze task characteristics to determine which verification approaches are most appropriate and prepares the contextual information needed for thorough evaluation.

The RAG component 702 might also retrieve historical evaluation data from previous optimization cycles. For instance, if a particular type of prompt has consistently led to higher-quality outputs in similar domains, the RAG component 702 can retrieve this historical context to inform the current optimization strategy. This ensures continuous improvement across evaluation sessions while applying lessons learned from previous optimization attempts. The AI agent system 104 orchestrates this process by determining which historical optimization data is relevant to the current task and how it should influence parameter adjustments, creating a self-improving system that progressively enhances output quality through intelligent evaluation and targeted refinement.

The RAG component 702 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 702 and the embeddings of the chunks along with the embeddings of the query may be compared to identify the most similar/related embeddings to the query, which may be supplied to the generative LM 707 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query)-to-graph query tool (NL-to-graph query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 702 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in’s REST interface such that the graph database is decoupled from the vector database and/or the embeddings models.

The tokenizer 705 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 707 to understand morphological variations and handle out-of-vocabulary words more effectively. Character-based tokenization represents each character as a separate token, enabling the generative LM 707 to process text at a fine-grained level. The choice of tokenization strategy may depend on factors such as the language being processed, the task at hand, and/or characteristics of the training dataset. As such, the tokenizer 705 may convert the (e.g., processed) text into a structured format according to tokenization schema being implemented in the particular embodiment.

The embedding component 706 may use any known embedding technique to transform discrete tokens into (e.g., dense, continuous vector) representations of semantic meaning. For example, the embedding component 706 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 703 includes image data/video data/etc., the input processor 704 may resize the data to a standard size compatible with the format of a corresponding input channel and/or may normalize pixel values to a common range (e.g., 0 to 1) to ensure a consistent representation, and the embedding component 706 may encode the image data using any known technique (e.g., using one or more convolutional neural networks (CNNs) to extract visual features). In some implementations in which the input 703 includes audio data, the input processor 704 may resample an audio file to a consistent sampling rate for uniform processing, and the embedding component 706 may use any known technique to extract and encode audio features—such as in the form of a spectrogram (e.g., a mel-spectrogram). In some implementations in which the input 703 includes video data, the input processor 704 may extract frames or apply resizing to extracted frames, and the embedding component 706 may extract features such as optical flow embeddings or video embeddings and/or may encode temporal information or sequences of frames. In some implementations in which the input 703 includes multi-modal data, the embedding component 706 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 707 and/or other components of the generative LLM system 700 may use different types of neural network architectures depending on the implementation. For example, transformer-based architectures such as those used in models like GPT may be implemented and may include self-attention mechanisms that weigh the importance of different words or tokens in the input sequence and/or feedforward networks that process the output of the self-attention layers, applying nonlinear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 706 may apply an encoded representation of the input 703 to the generative LM 707, and the generative LM 707 may process the encoded representation of the input 703 to generate an output 709, which may include responsive text and/or other types of data.

As described herein, in some embodiments, the generative LM 707 may be configured to access or use—or be capable of accessing or using—plug-ins/APIs 708 (which may include one or more plug-ins, application programming interfaces (APIs), databases, data stores, repositories, etc.). For example, for certain tasks or operations that the generative LM 707 is not ideally suited for, the model may have instructions (e.g., as a result of training, and/or based on instructions in a given prompt, such as those retrieved using the RAG component 702) to access one or more plug-ins/APIs 708 (e.g., third-party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-ins/APIs 708 to the plug-ins/APIs 708, the plug-ins/APIs 708 may process the information and return an answer to the generative LM 707, and the generative LM 707 may use the response to generate the output 709. This process may be repeated—e.g., recursively—for any number of iterations and using any number of plug-ins/APIs 708 until an output 709 that addresses each ask/question/request/process/operation/etc. from the input 703 can be generated. As such, the model(s) may not only rely on its own knowledge from training on a large dataset(s) and/or from data retrieved using the RAG component 702, but also on the expertise or optimized nature of one or more external resources—such as the plug-ins/APIs 708.

The generative LM 707 can access external resources through plug-ins/APIs 708 to enhance its capabilities beyond its internal knowledge base. This integration is particularly valuable in evaluation and optimization workflows performed by the AI agent system 104, where the generative LM 707 may need to verify outputs or access specialized domain knowledge. When processing complex coding tasks, for instance, the generative LM 707 can identify syntax patterns in user input and automatically initiate API calls to code verification tools like interpreters or linters, incorporating proper programming standards while preserving the original output structure. The system may recursively query multiple specialized verification resources—progressing from code execution to syntax validation and finally to style analysis—before generating comprehensive evaluation data that maintains output quality while incorporating expert verification signals.

In optimization implementations, the system orchestrates complementary verification through targeted API integrations, allowing the generative LM 707 to access code interpreters for functional validation while simultaneously querying style checkers and mathematical validators when appropriate. This coordinated multi-source integration creates comprehensive evaluation perspectives impossible with single-source information models, while maintaining consistent output quality assessment. Similarly, in mathematical verification contexts, the generative LM 707 can reference symbolic problem solvers through API connections, execute computational verifications through code interpreters, and verify logical consistency through mathematical validation tools—all while maintaining its evaluation objectives and optimization goals within a coherent evaluation-optimization cycle.

Furthermore, the plugin integration architecture supports conditional access patterns where verification tools are dynamically selected based on the output domain. The input processor 704 can be configured through the API call structure to implement rules such as "use code interpreters when programming outputs are detected" or "reference mathematical validators when processing proofs." The generative LM 707 processes these different plugin response streams within the context of the evaluation objectives, enabling sophisticated verification processes where multiple tools can build upon each other's verification signals while maintaining consistent evaluation standards. This approach significantly enhances the evaluation accuracy beyond what either standard comparison or single-tool verification can achieve, as the system maintains both comprehensive verification capabilities and access to specialized knowledge resources appropriate to each output domain.

In some embodiments, the LLMs/SLMs/VLMs/MMLMs/etc. may be implemented as components within AI agent workflows 116 that operate across multiple agent frameworks, requiring comprehensive performance analysis and optimization capabilities that extend beyond traditional model evaluation approaches. The AI agent system 104 described herein enables framework-agnostic instrumentation and analysis of these language model implementations regardless of whether they are deployed within LangChain, LlamaIndex, CrewAI, Semantic Kernel, or other agent framework environments. This approach allows developers to obtain unified performance insights across heterogeneous agent architectures where different language models may be integrated with various tools, retrievers, and memory components, creating complex multi-framework workflows that require standardized analysis methodologies.

The language models operating within these AI agent workflows 116 may be subject to comprehensive offline inference performance analysis through automated instrumentation that captures execution events, token usage patterns, latency characteristics, and behavioral metrics during workflow execution. The system may register custom callback handlers that intercept framework invocations including LLM calls, tool calls, and retriever operations, extracting relevant metadata such as input data, output data, token utilization, and execution timestamps from each intercepted invocation. This metadata extraction occurs transparently without requiring modifications to the underlying language model implementations, enabling developers to analyze performance efficiency metrics including latency analysis, bottleneck identification, concurrency analysis, and token efficiency measurements across different stages of agent workflow execution.

Furthermore, the performance analysis capabilities may include multi-concurrency simulation where language models are evaluated under varying concurrent request loads to identify performance bottlenecks that manifest only during concurrent processing scenarios. The system may generate standardized invocation traces that capture end-to-end workflow execution data, enabling identification of nested function bottlenecks, workflow ancestry tracking, and behavioral characteristic analysis at levels of granularity previously impossible across multiple agent frameworks. These comprehensive performance insights enable optimization of language model deployment strategies, prompt engineering approaches, and resource allocation decisions while maintaining compatibility with existing observability platforms through standardized data export mechanisms that support OpenTelemetry-compatible formats and cross-framework visualization capabilities.

FIG. 7B is a block diagram of an example implementation in which the generative LM 707 includes a transformer encoder-decoder. For example, assume input text such as “Who discovered gravity” is tokenized (e.g., by the tokenizer 705 of FIG. 7A) into tokens such as words, and each token is encoded (e.g., by the embedding component 706 of FIG. 7A) into a corresponding embedding. Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 710 of the generative LM 707.

In an example implementation, the encoder(s) 710 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, and a self-attention score may be calculated for pairs of tokens by taking the dot product of the query vector with the corresponding key vectors, normalizing the resulting scores, multiplying by corresponding value vectors, and summing weighted value vectors. The encoder 510 may apply multi-headed attention in which the attention mechanism is applied multiple times in parallel with different learned weight matrices. Any number of encoders may be cascaded to generate a context vector encoding the input. An attention projection layer 712 may convert the context vector into attention vectors (keys and values) for the decoder(s) 711.

In an example implementation, the decoder(s) 711 form a decoder stack, where each decoder includes a self-attention layer, an encoder-decoder self-attention layer that uses the attention vectors (keys and values) from the encoder 510 to focus on relevant parts of the input sequence, and a feedforward network. As with the encoder(s) 710, in an example transformer architecture, each token (e.g., word) flows through a separate path in the decoder(s) 711. During a first pass, the decoder(s) 711, a classifier 713, and a generation mechanism 720 may generate a first token, and the generation mechanism 720 may apply the generated token as an input during a second pass. The process may repeat in a loop, successively generating and adding tokens (e.g., words) to the output from the preceding pass and applying the token embeddings of the composite sequence with positional encodings as an input to the decoder(s) 711 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 710, except that it creates its queries from the layer below it and takes the keys and values (e.g., matrix) from the output of the encoder(s) 710.

As such, the decoder(s) 711 may output some decoded (e.g., vector) representation of the input being applied during a particular pass. The classifier 713 may include a multi-class classifier comprising one or more neural network layers that project the decoded (e.g., vector) representation into a corresponding dimensionality (e.g., one dimension for each supported word or token in the output vocabulary) and a SoftMax operation that converts logits to probabilities. As such, the generation mechanism 720 may select or sample a word or token based on a corresponding predicted probability (e.g., select the word with the highest predicted probability) and append it to the output from a previous pass, generating each word or token sequentially. The generation mechanism 720 may repeat the process, triggering successive decoder inputs and corresponding predictions until selecting or sampling a symbol or token that represents the end of the response, at which point the generation mechanism 720 may output the generated response.

FIG. 7C is a block diagram of an example implementation in which the generative LM 707 includes a decoder-only transformer architecture. For example, the decoder(s) 723 of FIG. 7C may operate similarly as the decoder(s) 711 of FIG. 7B except each of the decoder(s) 723 of FIG. 7C omits the encoder-decoder self-attention layer (since there is no encoder in this implementation). As such, the decoder(s) 723 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 723. As with the decoder(s) 711 of FIG. 7B, each token (e.g., word) may flow through a separate path in the decoder(s) 723, and the decoder(s) 723, a classifier 722, and a generation mechanism 721 may use auto-regression to sequentially generate one token at a time until predicting a symbol or token that represents the end of the response.

The classifier 722 and the generation mechanism 721 may operate similarly to the classifier 713 and the generation mechanism 720 of FIG. 7B, with the generation mechanism 721 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

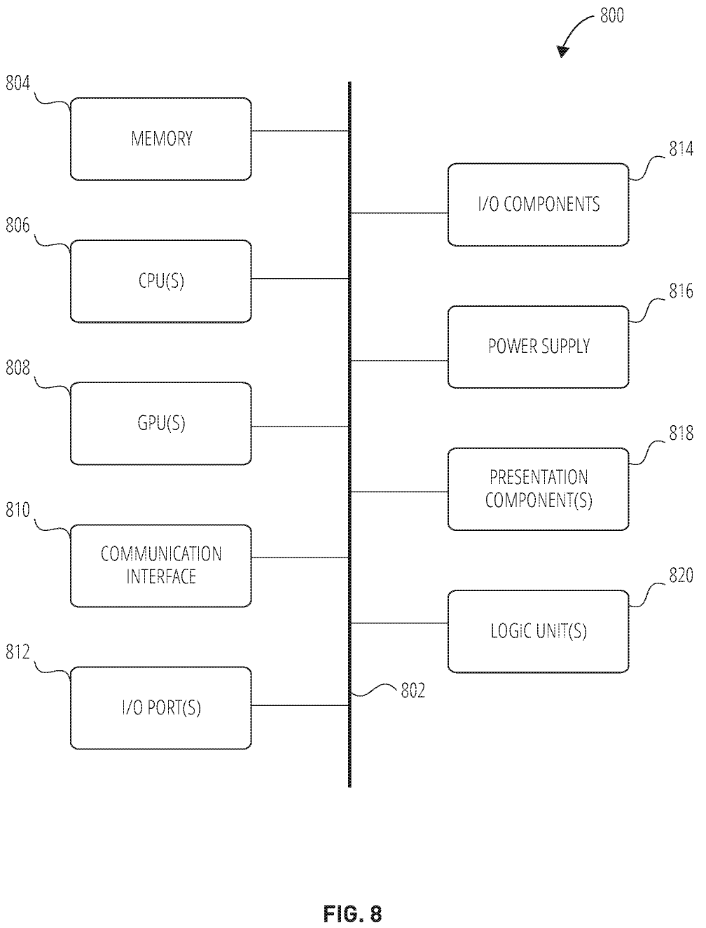

FIG. 8 is a block diagram of an example computing device 800 suitable for use in implementing some embodiments of the present disclosure. The computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output (I/O) components 814, a power supply 816, one or more presentation component(s) 818 (e.g., display(s)), and one or more logic unit(s) 820. In at least one embodiment, the computing device 800 may comprise one or more virtual machines (VMs), and/or any of the components thereof may comprise virtual components (e.g., virtual hardware components). For non-limiting examples, one or more of the GPU(s) 808 may comprise one or more vGPUs, one or more of the CPU(s) 806 may comprise one or more vCPUs, and/or one or more of the logic unit(s) 820 may comprise one or more virtual logic units. As such, a computing device 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component(s) 818, such as a display device, may be considered an I/O components 814 (e.g., if the display is a touch screen). As another example, the CPU(s) 806 and/or GPU(s) 808 may include memory (e.g., the memory 804 may be representative of a storage device in addition to the memory of the GPU(s) 808, the CPU(s) 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU(s) 806 may be directly connected to the memory 804. Further, the CPU(s) 806 may be directly connected to the GPU(s) 808. Where there is direct, or point-to-point connection between components, the interconnect system 802 may include a PCIe link to carry out the connection. In these examples, a PCI bus need not be included in the computing device 800. The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

In some embodiments specifically related to implementing the AI agent system 104 described in FIG. 1, the computing device 800 may be configured to provide framework-agnostic performance analysis of AI agent workflows 116 through automated instrumentation and standardized profiling capabilities. The memory 804 may store custom callback handlers, intermediate step stream data, and standardized metadata extracted from different agent frameworks, while maintaining execution traces and performance metrics collected during multi-concurrency workflow analysis. The CPU(s) 806, GPU(s) 808, and/or logic unit(s) 820 may work cooperatively to perform the distinct functions of the AI agent system 104, including automatic framework discovery, callback handler registration for intercepting framework invocations across LangChain, LlamaIndex, CrewAI, and Semantic Kernel implementations, metadata normalization into unified data models, and execution of specialized profiling algorithms that generate latency analysis, bottleneck identification, concurrency analysis, and token efficiency measurements that provide granular insights into workflow performance characteristics previously impossible to obtain across heterogeneous agent implementations.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPU(s) 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU(s) 808 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic unit(s) 820 may be part of and/or integrated in one or more of the CPU(s) 806 and/or the GPU(s) 808 and/or one or more of the logic unit(s) 820 may be discrete components or otherwise external to the CPU(s) 806 and/or the GPU(s) 808. In embodiments, one or more of the logic unit(s) 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) – which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, including wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O port(s) 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may include one or more depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertial measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

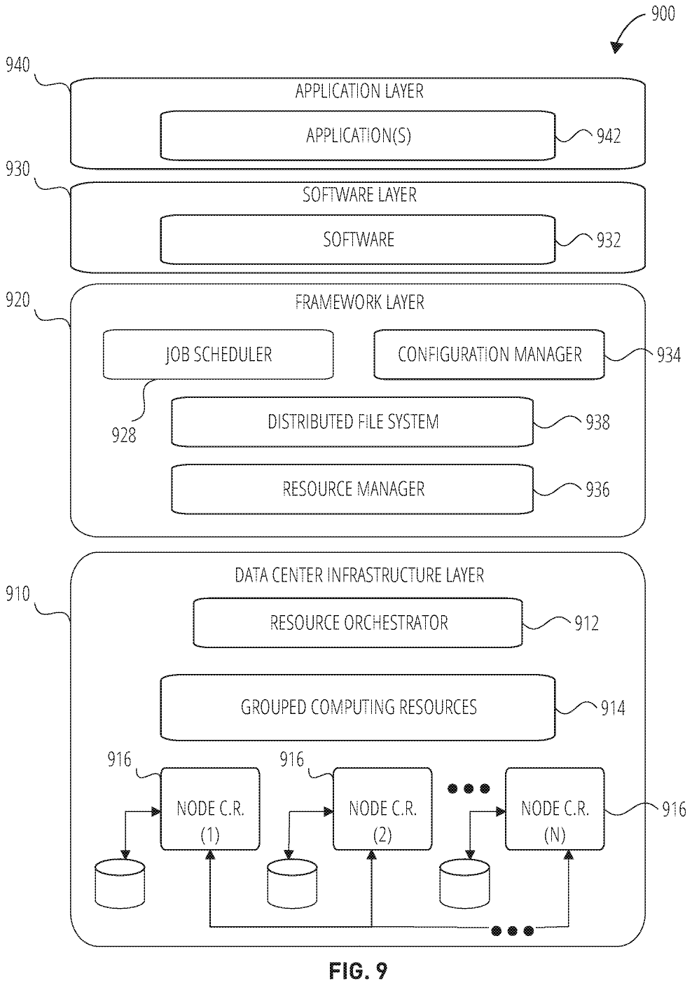

FIG. 9 illustrates an example data center 900 that may be used in at least one embodiment of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources 916 (“node C.R.s”), shown as (1)-(N), where “N” represents any whole, positive integer. In at least one embodiment, node computing resources 916 may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more nodes from among the node computing resources 716 may correspond to a server having one or more of the above-mentioned computing resources. In addition, in some embodiments, the node computing resources 916 may include one or more virtual components, such as vGPUs, vCPUs, and/or the like, and/or one or more of the node computing resources 916 may correspond to a virtual machine (VM).

In at least one embodiment, the grouped computing resources 914 may include separate groupings of the node computing resources 916 housed within one or more racks (not shown), or many racks housed in data centers at various geographical locations (also not shown). Separate groupings of node computing resources 916 within the grouped computing resources 914 may include grouped compute, network, memory or storage resources that may be configured or allocated to support one or more workloads. In at least one embodiment, several node computing resources 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node computing resources 916 and/or grouped computing resources 914. In at least one embodiment, the resource orchestrator 912 may include a software design infrastructure (SDI) management entity for the data center 900. The resource orchestrator 912 may include hardware, software, or some combination thereof.

In at least one embodiment, as shown in FIG. 9, the framework layer 920 may include a job scheduler 928, a configuration manager 934, a resource manager 936, and/or a distributed file system 938. The framework layer 920 may include a framework to support the software 932 of the software layer 930 and/or one or more application(s) 942 of the application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark^{TM} (hereinafter “Spark”) that may use the distributed file system 938 for large-scale data processing (e.g., "big data"). In at least one embodiment, the job scheduler 928 may include a Spark driver to facilitate scheduling of workloads supported by various layers of the data center 900. The configuration manager 934 may be capable of configuring different layers such as the software layer 930 and the framework layer 920 including Spark and the distributed file system 938 for supporting large-scale data processing. The resource manager 936 may be capable of managing clustered or grouped computing resources mapped to or allocated for support of the distributed file system 938 and the job scheduler 928. In at least one embodiment, clustered or grouped computing resources may include the grouped computing resources 914 at the data center infrastructure layer 910. The resource manager 936 may coordinate with the resource orchestrator 912 to manage these mapped or allocated computing resources.

In at least one embodiment, the software 932 included in the software layer 930 may include software used by at least portions of the node computing resources 916, grouped computing resources 914, and/or the distributed file system 938 of the framework layer 920. One or more types of software may include, but are not limited to, Internet web page search software, e-mail virus scan software, database software, and streaming video content software.

In at least one embodiment, the application(s) 942 included in the application layer 940 may include one or more types of applications used by at least portions of the node computing resources 916, grouped computing resources 914, and/or distributed file system 938 of the framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of the configuration manager 934, resource manager 936, and resource orchestrator 912 may implement any number and type of self-modifying actions based on any amount and type of data acquired in any technically feasible fashion. Self-modifying actions may relieve a data center operator of the data center 900 from making possibly bad configuration decisions and possibly avoiding underutilized and/or poor performing portions of a data center. Each layer of the data center 900 contributes functionality to the AI agent system 104.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

The AI agent system 104 of FIG. 1 is designed to perform comprehensive offline inference performance analysis of AI agent workflows 116 across multiple deployment layers of the data center 900 without requiring modifications to existing agent implementations. The AI agent system 104 can automatically discover and instrument agent workflows built using different frameworks such as LangChain, LlamaIndex, CrewAI, and Semantic Kernel while maintaining complete end-to-end observability through standardized intermediate step streams across all layers of the data center 900 infrastructure.

At the application layer 940, the AI agent system 104 can analyze application(s) 942 that implement AI agent workflows 116 by registering custom callback handlers for each discovered agent framework to intercept framework invocations. The API server 114 coordinates with application(s) 942 running at the application layer 940 to collect execution events from agent workflows during multi-concurrency evaluation, enabling the profiler component 112 to generate performance efficiency metrics including latency analysis, bottleneck identification, and token efficiency measurements that help developers understand how their agent implementations behave across different deployment scenarios.

Within the software layer 930, the AI agent system 104 interfaces with software 932 components to extract metadata including input data, output data, token usage statistics, and execution timestamps from intercepted framework invocations. The evaluation system 106 works with the software layer 930 to normalize extracted metadata across different frameworks into a unified data model that gets published to an intermediate step stream, enabling the telemetry component 124 to collect comprehensive execution traces that capture end-to-end workflow execution data including function ancestry information and hierarchical relationships between workflow components.

At the framework layer 920, the AI agent system 104 coordinates with the job scheduler 928, configuration manager 934, and resource manager 936 to enable framework-agnostic performance analysis across heterogeneous agent implementations. The configuration 110 component works with the configuration manager 934 to define evaluation criteria, performance thresholds, and analysis parameters that guide the profiling process. The profiler component 112 leverages the distributed file system 938 to store standardized invocation traces and execution data that enable comprehensive behavioral analysis across multiple framework boundaries.

At the data center infrastructure layer 910, the AI agent system 104 communicates with the resource orchestrator 912 to coordinate performance analysis across grouped computing resources 914 and node computing resources 916 where agent workflows are deployed. The observability platform 126 exports trace data to infrastructure monitoring systems through the resource orchestrator 912, enabling cross-framework observability where agent workflows built in one framework can be visualized using tools associated with different frameworks. The comprehensive instrumentation capabilities enable the AI agent system 104 to provide granular insights into workflow performance characteristics previously impossible to obtain across multi-framework agent architectures deployed across the data center 900 infrastructure.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device 800 of FIG. 8—e.g., each device may include similar components, features, and/or functionality of the computing device 800. In addition, where backend devices (e.g., servers, NAS, etc.) are implemented, the backend devices may be included as part of the data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or operations or combinations of steps or operations similar to the ones described in this document, in conjunction with other present or future technologies. Moreover, although the terms “step” and/or “block” and/or “operation” may be used herein to connote different elements of methods employed, the terms should not be interpreted as implying any particular order among or between various steps herein disclosed unless and except when the order of individual steps is explicitly described.

### EXAMPLES

Specific example embodiments are now described. In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1. One or more processors comprising processing circuitry to perform operations comprising: receiving, by an artificial intelligence (AI) agent system, one or more AI agent workflows created using different AI agent frameworks, the AI agent system configured to provide AI framework-agnostic abstractions of the one or more AI agent workflows by wrapping individual functions with standardized schemas and descriptions; generating, by the AI agent system, instrumentation data for the one or more AI agent workflows based on one or more execution events of the one or more AI agent workflows; and modifying, by the AI agent system, the one or more AI agent workflows based on one or more performance efficiency metrics generated from the instrumentation data.

Example 2. The one or more processors of Example 1, wherein the operations comprise: wrapping one or more agent functions with standardized interfaces that define the standardized schemas, and descriptions; and registering wrapped functions with the AI agent system that maintains information about tools, agents, and functions across the different AI agent frameworks used to create the one or more AI agent workflows.

Example 3. The one or more processors of any one of Examples 1-2, wherein the operations comprise: inspecting source code of the one or more AI agent workflows to identify undeclared agent frameworks; automatically discovering one or more language model (LM) frameworks used in function definitions of the one or more AI agent workflows by analyzing at least one of code structure or library imports; registering custom callback handlers for each identified undeclared agent framework to intercept framework invocations; and generating standardized data for the one or more AI agent workflows by extracting metadata including at least one of input data, output data, or token usage from the intercepted framework invocations through the custom callback handlers.

Example 4. The one or more processors of any one of Examples 1-3, wherein the operations comprise: normalizing the extracted metadata across different frameworks into a unified data model; and publishing the normalized metadata to an intermediate step stream.

Example 5. The one or more processors of any one of Examples 1-4, wherein the operations comprise: receiving one or more events from one or more functions publishing the normalized metadata to the intermediate step stream; appending hierarchy metadata including parent function calls and ancestry information to each of the one or more events; forwarding the one or more events to registered subscribers through asynchronous callback handlers; and maintaining a ledger of actions taken by the one or more AI agent workflows during processing of each of the one or more events.

Example 6. The one or more processors of any one of Examples 1-4, wherein the operations comprise: subscribing to the intermediate step stream through multiple subscriber types including evaluation subscribers and profiler subscribers; exporting trace data to observability platforms using OpenTelemetry-compatible formats; converting intermediate steps into framework-specific visualization formats for different observability tools; and enabling cross-framework observability where the one or more AI agent workflows built in one framework can be visualized using tools associated with a different framework.

Example 7. The one or more processors of any one of Examples 1-6, wherein the operations comprise: executing the one or more AI agent workflows across multiple concurrency levels; simulating user load patterns by varying a number of simultaneous requests processed by the one or more AI agent workflows; collecting execution traces during the simulating of the user load patterns; generating standardized invocation traces that capture end-to-end workflow execution data; and generating the one or more performance efficiency metrics based on the standardized invocation traces.

Example 8. The one or more processors of Example 7, wherein the operations comprise: analyzing language model (LM) latency measurements across different parts of the one or more AI agent workflows; calculating end-to-end workflow runtime statistics for each concurrency level of the multiple concurrency levels; identifying performance bottlenecks by examining execution timestamps and function call durations for each of the one or more AI agent workflows; and generating latency analysis reports representing the performance bottlenecks.

Example 9. The one or more processors of any one of Examples 7-8, wherein the operations comprise: tracking function ancestry relationships to identify nested function call hierarchies; analyzing timestamps and event types to identify bottleneck locations within nested functions; and determining which LM calls or tool invocations are causing latencies that fail to meet latency criteria.

Example 10. The one or more processors of any one of Examples 1-9, wherein the operations comprise: capturing input token counts and output token counts for each of a plurality of LM invocations within the one or more AI agent workflows; recording timestamps and metadata for tool calls and language model calls during execution of the one or more AI agent workflows; generating standardized data frames containing token usage patterns across different workflow stages of the one or more AI agent workflows; and computing, based on the standardized data frames, one or more token efficiency metrics as a function of prompt token versus completion token ratios.

Example 11. The one or more processors of any one of Examples 1-10, wherein an AI agent workflow comprises: a sequence of processes that use a LM to reason through a problem and create a plan to solve the problem; iterative execution of the plan using a set of tools; and one or more AI agents that can call one or more tools of the set of tools in a sequence or in parallel to accomplish specific tasks of the plan.

Example 12. The one or more processors of any one of Examples 1-11, wherein the one or more performance efficiency metrics comprise at least one of: one or more latency analysis metrics that measure LM latency and end-to-end workflow runtimes across different parts of an AI agent workflow; one or more bottleneck analysis metrics that identify certain functions and specific LMs or tool components causing latency using function ancestry or timestamps; one or more concurrency analysis metrics that represent regions of high concurrency in AI agent workflow executions and estimate LM inference latency during peak usage periods; or one or more token efficiency metrics that analyze input token versus completion token ratios and identify token usage patterns at various stages of the AI agent workflow.

Example 13. The one or more processors of any one of Examples 1-12, wherein the instrumentation data comprises at least one of: execution event data captured through custom callback handlers including one or more of timestamps, input data, output data, or token usage for each of a plurality of LM calls, tool calls, or function calls; function ancestry information that tracks which functions called other functions and maintains hierarchical relationships between AI agent workflow components; metadata extracted from framework invocations; and intermediate step stream data that provides a standardized ledger of actions taken by the AI agent workflow during execution of each AI agent workflow.

Example 14. The one or more processors of any one of Examples 1-13, wherein the one or more processors are comprised in at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

Example 15. A system comprising one or more processors to perform operations comprising: receiving, by an artificial intelligence (AI) agent system, one or more AI agent workflows created using different AI agent frameworks, the AI agent system configured to provide AI framework-agnostic abstractions of the one or more AI agent workflows by wrapping individual functions with standardized schemas and descriptions; generating, by the AI agent system, instrumentation data for the one or more AI agent workflows based on one or more execution events of the one or more AI agent workflows; and modifying, by the AI agent system, the one or more AI agent workflows based on one or more performance efficiency metrics generated from the instrumentation data.

Example 16. The system of Example 15, wherein the operations comprise: wrapping one or more agent functions with standardized interfaces that define the standardized schemas, and descriptions; and registering wrapped functions with the AI agent system that maintains information about tools, agents, and functions across the different AI agent frameworks used to create the one or more AI agent workflows.

Example 17. The system of any one of Examples 15-16, wherein the system is comprised in at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

Example 18. A method comprising: receiving, by an artificial intelligence (AI) agent system, one or more AI agent workflows created using different AI agent frameworks, the AI agent system configured to provide AI framework-agnostic abstractions of the one or more AI agent workflows by wrapping individual functions with standardized schemas and descriptions; generating, by the AI agent system, instrumentation data for the one or more AI agent workflows based on one or more execution events of the one or more AI agent workflows; and modifying, by the AI agent system, the one or more AI agent workflows based on one or more performance efficiency metrics generated from the instrumentation data.

Example 19. The method of Example 18, further comprising: wrapping one or more agent functions with standardized interfaces that define the standardized schemas, and descriptions; and registering wrapped functions with the AI agent system that maintains information about tools, agents, and functions across the different AI agent frameworks used to create the one or more AI agent workflows.

Example 20. The method of any one of Examples 18-19, wherein the method is performed by at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational artificial intelligence (AI) operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

What is claimed is:

1. One or more processors comprising processing circuitry to perform operations comprising:
receiving, by an artificial intelligence (AI) agent system, one or more AI agent workflows created using different AI agent frameworks, the AI agent system configured to provide AI framework-agnostic abstractions of the one or more AI agent workflows by wrapping individual functions with standardized schemas and descriptions;
generating, by the AI agent system, instrumentation data for the one or more AI agent workflows based on one or more execution events of the one or more AI agent workflows; and
adjusting, by the AI agent system, a deployment configuration for the one or more AI agent workflows based on one or more performance efficiency metrics generated from the instrumentation data.

2. The one or more processors of claim 1, wherein the operations comprise:
wrapping one or more agent functions with standardized interfaces that define standardized schemas and descriptions; and
registering the wrapped one or more agent functions with the AI agent system that maintains information about tools, agents, and functions across the different AI agent frameworks used to create the one or more AI agent workflows.

3. The one or more processors of claim 1, wherein the operations comprise:
inspecting source code of the one or more AI agent workflows to identify undeclared agent frameworks;
automatically discovering one or more language model (LM) frameworks used in function definitions of the one or more AI agent workflows by analyzing at least one of code structure or library imports;
registering custom callback handlers for each identified undeclared agent framework to intercept framework invocations; and
generating standardized data for the one or more AI agent workflows by extracting metadata including at least one of input data, output data, or token usage from the intercepted framework invocations through the custom callback handlers.

4. The one or more processors of claim 3, wherein the operations comprise:
normalizing the extracted metadata across different frameworks into a unified data model; and
publishing the normalized metadata to an intermediate step stream.

5. The one or more processors of claim 4, wherein the operations comprise:
receiving one or more events from one or more functions publishing the normalized metadata to the intermediate step stream;
appending hierarchy metadata including parent function calls and ancestry information to each of the one or more events;
forwarding the one or more events to registered subscribers through asynchronous callback handlers; and
maintaining a ledger of actions taken by the one or more AI agent workflows during processing of each of the one or more events.

6. The one or more processors of claim 4, wherein the operations comprise:
subscribing to the intermediate step stream through multiple subscriber types including evaluation subscribers and profiler subscribers;
exporting trace data to observability platforms using OpenTelemetry-compatible formats;
converting intermediate steps into framework-specific visualization formats for different observability tools; and
enabling cross-framework observability where the one or more AI agent workflows built in one framework can be visualized using tools associated with a different framework.

7. The one or more processors of claim 1, wherein the operations comprise:
executing the one or more AI agent workflows across multiple concurrency levels;
simulating user load patterns by varying a number of simultaneous requests processed by the one or more AI agent workflows;
collecting execution traces during the simulating of the user load patterns;
generating standardized invocation traces that capture end-to-end workflow execution data; and
generating the one or more performance efficiency metrics based on the standardized invocation traces.

8. The one or more processors of claim 7, wherein the operations comprise:
analyzing language model (LM) latency measurements across different parts of the one or more AI agent workflows;
calculating end-to-end workflow runtime statistics for each concurrency level of the multiple concurrency levels;
identifying performance bottlenecks by examining execution timestamps and function call durations for each of the one or more AI agent workflows; and
generating latency analysis reports representing the performance bottlenecks.

9. The one or more processors of claim 8, wherein the operations comprise:
tracking function ancestry relationships to identify nested function call hierarchies;
analyzing timestamps and event types to identify bottleneck locations within nested functions; and
determining which LM calls or tool invocations are causing latencies that fail to meet latency criteria.

10. The one or more processors of claim 1, wherein the operations comprise:
capturing input token counts and output token counts for each of a plurality of LM invocations within the one or more AI agent workflows;
recording timestamps and metadata for tool calls and language model calls during execution of the one or more AI agent workflows;
generating standardized data frames containing token usage patterns across different workflow stages of the one or more AI agent workflows; and
computing, based on the standardized data frames, one or more token efficiency metrics as a function of prompt token versus completion token ratios.

11. The one or more processors of claim 1, wherein an AI agent workflow of the one or more AI agent workflows comprises:
a sequence of processes that use a LM to reason through a problem and create a plan to solve the problem;
iterative execution of the plan using a set of tools; and
one or more AI agents that can call one or more tools of the set of tools in a sequence or in parallel to accomplish specific tasks of the plan.

12. The one or more processors of claim 1, wherein the one or more performance efficiency metrics comprise at least one of:
one or more latency analysis metrics that measure LM latency and end-to-end workflow runtimes across different parts of an AI agent workflow;
one or more bottleneck analysis metrics that identify certain functions and specific LMs or tool components causing latency using function ancestry or timestamps;
one or more concurrency analysis metrics that represent regions of high concurrency in AI agent workflow executions and estimate LM inference latency during peak usage periods; or
one or more token efficiency metrics that analyze input token versus completion token ratios and identify token usage patterns at various stages of the AI agent workflow.

13. The one or more processors of claim 1, wherein the instrumentation data comprises at least one of:
execution event data captured through custom callback handlers including one or more of timestamps, input data, output data, or token usage for each of a plurality of LM calls, tool calls, or function calls;
function ancestry information that tracks which functions called other functions and maintains hierarchical relationships between AI agent workflow components;
metadata extracted from framework invocations; and
intermediate step stream data that provides a standardized ledger of actions taken by the AI agent workflow during execution of each AI agent workflow.

14. The one or more processors of claim 1, wherein the one or more processors are comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.

15. A system comprising one or more processors to perform operations comprising:
receiving, by an artificial intelligence (AI) agent system, one or more AI agent workflows created using different AI agent frameworks, the AI agent system configured to provide AI framework-agnostic abstractions of the one or more AI agent workflows by wrapping individual functions with standardized schemas and descriptions;
generating, by the AI agent system, instrumentation data for the one or more AI agent workflows based on one or more execution events of the one or more AI agent workflows; and
adjusting, by the AI agent system, a deployment configuration for the one or more AI agent workflows based on one or more performance efficiency metrics generated from the instrumentation data.

16. The system of claim 15, wherein the operations comprise:
wrapping one or more agent functions with standardized interfaces that define the standardized schemas and descriptions; and
registering the wrapped functions with the AI agent system that maintains information about tools, agents, and functions across the different AI agent frameworks used to create the one or more AI agent workflows.

17. The system of claim 15, wherein the system is comprised in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.

18. A method comprising:
receiving, by an artificial intelligence (AI) agent system, one or more AI agent workflows created using different AI agent frameworks, the AI agent system configured to provide AI framework-agnostic abstractions of the one or more AI agent workflows by wrapping individual functions with standardized schemas and descriptions;
generating, by the AI agent system, instrumentation data for the one or more AI agent workflows based on one or more execution events of the one or more AI agent workflows; and
modifying, by the AI agent system, the one or more AI agent workflows based on one or more performance efficiency metrics generated from the instrumentation data.

19. The method of claim 18, further comprising:
wrapping one or more agent functions with standardized interfaces that define the standardized schemas and descriptions; and
registering the wrapped functions with the AI agent system that maintains information about tools, agents, and functions across the different AI agent frameworks used to create the one or more AI agent workflows.

20. The method of claim 18, wherein the method is performed by at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.
